(19) United States
(12) Patent Application Publication
(10) Pub. No.: US 2026/0109547 A1
(43) Pub. Date: Apr. 23, 2026

(54) METHOD FOR TRANSFERRING GOODS BETWEEN CONTAINERS, AND TRANSFER DEVICE AND TURNING DEVICE THEREFOR

(71) Applicant: TGW Logistics GMBH, Marchtrenk (AT)

(72) Inventors: Stefan HOLZNER, Zaisering (DE); Sascha HROH, Brannenburg (DE); Thomas SCHLOSSER, Frasdorf (DE); Florian FORSTER, Bad Endorf (DE); Franziska Hildegard SCHNEIDER, Rohrdorf (DE); Fabian DOBIASCH, Stephanskirchen (DE)

(73) Assignee: TGW Logistics GMBH, Marchtrenk (AT)

(21) Appl. No.: 19/114,239

(22) PCT Filed: Sep. 22, 2023
(86) PCT No.: PCT/AT2023/060331

§ 371 Date: Mar. 21, 2025

(30) Foreign Application Priority Data
Sep. 23, 2022 (AT) A50734/2022

(51) Int. Cl. B65G 47/244; B65G 13/07; B65G 13/075; B65G 41/00; B65G 47/29

(52) U.S. Cl. CPC B65G 47/2445; B65G 13/07; B65G 13/075; B65G 41/002; B65G 47/295

(57) ABSTRACT

The disclosure relates to a turning device and a method for turning containers, wherein the containers are received between two turning conveying devices. The turning conveying devices are rotated about an axis of rotation in order to turn the containers. Furthermore, the disclosure relates to a transfer device and a method for transferring an article from a receiving container to a transferring container, wherein a receiving container is put over a transferring container at a put-over station in order to form a turning pair. The turning pair is turned by the turning device. Subsequently, the transferring container can be removed from the receiving container at a removal station in order to transfer the article to the receiving container.

### BACKGROUND

The disclosure relates to a turning device for containers, in particular for a turning pair comprising a transferring container and a receiving container put over the transferring container, with a container manipulation unit for transporting and turning the containers and a rotating device for rotating the container manipulation unit, wherein the container manipulation unit comprises a first turning conveying device with a first conveying plane, a second turning conveying device with a second conveying plane. The first and second conveying planes are arranged mutually opposite and facing each other, wherein the containers can be positioned between the first and second turning conveying devices. The disclosure further relates to a method for turning containers by a turning device, in particular by a turning device according to the disclosure.

Furthermore, the disclosure relates to a method for transferring an article from a transferring container to a receiving container by a transfer device, in particular a transfer device described below. The disclosure further relates to a transfer device for transferring an article from a transferring container to a receiving container, in particular for executing a method according to the disclosure, comprising a first provisioning device for provisioning transferring containers, a second provisioning device for provisioning receiving containers and a turning device for turning the transferring containers in order to transfer the article from the transferring container to the receiving container.

Finally, the disclosure relates to an order picking warehouse for executing such a method, comprising an article receipt for receiving articles which are delivered in transferring containers, a transfer device for transferring the articles from the transferring containers to receiving containers, an article storage for storing the articles in the receiving containers, a picking station for reloading articles from the receiving containers into shipping containers according to picking orders, a storage conveying system for transporting the receiving containers between the transfer device and the article storage and a picking conveying system for transporting the receiving containers between the storage and the picking station.

In order picking warehouses, it is often required that an article be reloaded and/or transferred from a transferring container filled with an article to an empty or only partially filled receiving container. For example, an article is supplied to the order picking warehouse in a supply container, in particular in a cardboard box, and are to be transferred to a storage container, in particular to a case. This is referred to as a so-called decanting of articles. During decanting, the supply containers essentially provision the transferring containers, and the storage containers provision the receiving containers.

Known from the prior art are devices and methods for emptying containers and for transferring an article from a transferring container to a receiving container and devices and methods for turning containers.

EP 2 644 515 A1 discloses a method and a device for emptying a transferring container, in particular for emptying crates of beverages. Here, the transferring container is enclosed by a rim and is turned along with the rim, wherein the bottles from the crate of beverages are transferred into the rim while oriented upside down. The crate of beverages is removed from the rim and the rim is then turned back. The turning back of the rim reorients the bottles upright again, so that the bottles can then be transferred downward onto a support by opening the rim. Here, the bottles are not reloaded into a receiving container, however. Another disadvantage is that essentially two rotational movements must be executed before the bottles can be processed further.

Known from US 2021/0101759 A1 is a two-step method and a device for transferring an article from a transferring container to a receiving container. The article is first tipped out of the transferring container onto a receiving surface by pivoting the transferring container. Subsequently, the article is tipped into the receiving container by pivoting the receiving surface. It is disadvantageous here that the article is meanwhile protected and/or enclosed neither by the transferring container nor by the receiving container, so that there is a risk of in particular small items getting lost or items being damaged while being inserted in the receiving container, for example because the items rub against or get caught on edges of the receiving container.

EP 2 762 426 A1 discloses a device for turning an object, in particular a packet of stacked sacks. This device comprises two mutually opposite turning conveying devices, wherein the object is wedged therebetween. The turning conveying devices are rotated about a horizontal axis of rotation, wherein the wedged object is turned. Using the turning conveying device, which is now arranged at the bottom, the object can be transported out of the device. It is disadvantageous here that a complex transmission is required for a driving force from a stationary drive device to the rotatable conveying devices.

### Overview

It is therefore an object of the disclosure to create an improved device and an improved method for turning containers, for example turning pairs. In particular, the turning of the containers is to enable a simple and reliable automated transfer of an article from a transferring container to a receiving container.

Furthermore, it is an object of the disclosure to create an improved method and an improved transfer device for transferring an article from a transferring container to a receiving container.

It is a further object of the disclosure to create an improved order picking warehouse in which an article can be transferred from a transferring container to a receiving container in a simple and reliable manner.

The first object is achieved with a turning device of the kind mentioned in the beginning, in which the rotating device comprises a pivoting frame and a support structure, wherein the pivoting frame is mounted at the support structure so as to be rotatable about an axis of rotation and the first and second turning conveying devices are arranged at the pivoting frame. A rotation of the pivoting frame of the rotating device therefore results in a turning of a turning pair.

The first and second turning conveying devices can each comprise multiple optional conveyor rollers, wherein at least one conveyor roller of each of the conveyor rollers is configured as a, in particular gearless, motor roller with a drive device. Alternatively or additionally, the container manipulation unit can comprise an optional clamping device, which is configured for fixing the containers between the first and second turning conveying devices. The conveyor rollers allow a transport of the turning pair inside the turning device and a reception of the turning pair in the turning device and a transfer of the turning pair from the turning device. The clamping device ensures a secure hold of the turning pair during the turning operation.

Furthermore, the first object is achieved with a method for turning containers which comprises the following steps:
a) provisioning a container manipulation unit for transporting and turning the containers which comprises a first turning conveying device and a second turning conveying device, wherein the first turning conveying device forms a first conveying plane and the second turning conveying device forms a second conveying plane, wherein the first conveying plane and the second conveying plane are arranged at a normal distance from each other (defined at least by the height of the turning pair) and opposite each other,
b) provisioning a turning pair, comprising a transferring container and a receiving container put over the transferring container, in the container manipulation unit between the first turning conveying device and the second turning conveying device,
c) optionally fixing the turning pair between the first turning conveying device and the second turning conveying device of the container manipulation unit, in particular by a clamping device of the container manipulation unit,
d) rotating the container manipulation unit, in particular by the rotating device of the turning device and in particular by more than 90°, preferably by at least 120°, particularly preferably by 180°, about a horizontal axis of rotation, and turning the turning pair, wherein in particular the drive device of the motor rollers is moved along,
e) transferring the turning pair to the second turning conveying device, wherein the receiving container of the turning pair is deposited with its bottom onto a second conveying plane formed by the second turning conveying device,
f) transporting the turning pair out of the container manipulation unit.

Advantageously,
the first turning conveying device of the container manipulation unit provisioned in step a) can comprise at least one self-driven motor roller with a drive device and the second turning conveying device of the container manipulation unit provisioned in step a) can comprise a self-driven motor roller with a drive device,
in step b), the at least one motor roller of the first turning conveying device can be driven by its drive device in order to position the turning pair in the container manipulation unit
the turning pair can be transported out of the container manipulation unit in step f) by driving the at least one motor roller of the second turning conveying device by its drive device.

Analogous methods can also be provided for one container alone, wherein the container takes the place of the turning pair.

It is further conceivable that one or multiple of the steps c), d), e) f) are each executed for multiple turning pairs or multiple containers simultaneously.

One advantage achieved with the disclosure is in particular that the use of self-driven motor rollers enables their drive devices to be essentially moved along during rotation of the turning conveying device, whereby a complex mechanism for transmitting a driving force from a stationary drive device to a mobile, in particular rotatable, turning conveying device is not required. This ensures, on the one hand, that containers can be turned in a particularly reliable and simple manner. On the other hand, maintenance requirements are reduced as a, in particular rotation-invariant, power transmission mechanism, for example with belt transmissions, gears and suchlike, is not required. The maintenance requirements can be reduced additionally if the motor roller is configured as a gearless motor roller, for example.

Transferring containers and receiving containers are containers. As a rule, containers are configured for each containing an article. To that end, a container can have a bottom and an open side opposite the bottom. Expediently, the container comprises side walls rising up from the bottom. It can be provided here that top edges of the side walls limit the open side. Optionally, a container, in particular the transferring container, can be closed by a cover opposite the bottom. To provision the open side, the cover can have an open window which was cut into the cover, for example. In this case, the open side is bound by the cover, in particular by edges of the window.

Generally, containers can be transported and/or provisioned in different orientation by a conveying device, in particular by the turning conveying device. Here, a distinction can be made in particular between an upright orientation and an upside-down orientation. In the upright orientation, the respective container is oriented with its bottom downward and with its open side upward. Upright orientation is thus understood to mean in particular that the bottom of the respective container is facing a provisioning plane, on which the respective container can be deposited. Here, the container can rest with its bottom on the provisioning plane. In the upside-down orientation, the respective container is oriented with its open side downward and with its bottom upward. Upside-down orientation is thus understood to mean in particular that the bottom of the respective container is facing away from the provisioning plane, on which the respective container can be deposited. Here, the container can rest, for example with top edges of its side walls or with an optional cover, on the provisioning plane. The provisioning planes can be formed, for example, by the first and/or second provisioning devices described below and/or by one or multiple of the conveying planes described below.

Preferably, it is provided that the receiving container is dimensioned such that the transferring container can be received in the receiving container and/or the receiving container can be put over the transferring container. A height of the transferring container is preferably equal to or smaller than a height of the receiving container, so that it is ensured that all items of the article of the transferring container can be received in the receiving container. However, it may also be provided in some cases that the height of the transferring container is greater than the height of the receiving container.

The first turning conveying device and/or the second turning conveying device is preferably configured as a roller conveyor. It can alternatively be provided that the first turning conveying device and/or the second turning conveying device is configured as a belt conveyor, in particular as dual track belt conveyor. It can be provided here that the respective turning conveying device comprises a conveyor belt or multiple conveyor belts and at least two conveyor rollers, around which the conveyor belt or the conveyor belts are arranged circumferentially. Here, the conveyor belt or the conveyor belts can be driven by the at least one motor roller.

It is preferably provided that the first conveying plane and second conveying plane are defined and/or formed by the conveyor rollers of the respective turning conveying device. It may be provided here that containers are deposited and/or transported immediately on the conveyor rollers. In this case, the respective conveying plane is defined and formed by the conveyor rollers. Alternatively, the conveying planes can extend spaced apart from the conveyor rollers, for example because a conveyor belt is tensioned around the conveyor rollers. In this case, the conveying planes, while being defined by the conveyor rollers, are formed by the conveyor belt.

It is favorable if the motor roller comprises a roller axle and a roller body mounted so as to be rotatable relative thereto and the drive device comprises an electric motor, in particular a DC motor, which is arranged inside the roller body. Preferably, the electric motor comprises a rotor, in particular connected to the roller body, and a stator, which are arranged coaxially to the roller axle. Here, the rotor can have a plurality of permanent magnets, which are connected to the roller body. Furthermore, the stator can have multiple stator lamination bundles with windings. The windings can be supplied by a drive electronics system, preferably with a DC voltage of smaller than 50 V (safety extra low voltage), in particular 24 V or 48 V, for example. Preferably, the electric motor is thus configured as an external rotor motor.

Furthermore, it is advantageous if the first and/or second turning conveying device each have one or multiple roller groups, wherein each roller group comprises a conveyor roller configured as a motor roller and multiple passive conveyor rollers, wherein the passive conveyor rollers of a roller group are connected to the motor roller of the roller group via a belt transmission in order to transmit a driving force from the motor roller to the passive conveyor rollers. This enables the driving force of one motor roller to be used for multiple conveyor rollers, wherefore fewer motor rollers and also fewer drive devices are required.

To fix and/or brake the conveyor rollers during a rotation of the container manipulation unit and thus avoid an inadvertent moving of a container to be turned, in particular of the turning pair, out of the container manipulation unit, it is preferably provided that the container manipulation unit further comprises a braking system, using which at least one of the conveyor rollers, in particular the at least one motor roller, of the first turning conveying device and at least one of the conveyor rollers, in particular the at least one motor roller, of the second turning conveying device can be acted upon by a holding force. It is thus favorable if the at least one self-driven motor roller of the first turning conveying device and/or the at least one self-driven motor roller of the second turning conveying device is acted upon by a holding force in step d). These measures enable the use of a lower clamping force for fixing the container or the turning pair and thereby a particularly careful handling of the containers and of the article located therein. To reduce the clamping force further, it can be provided that the conveyor rollers are equipped with a non-slip layer, for example with a rubber coating.

Particularly preferably, it is provided that at least one of the conveyor rollers, in particular the at least one motor roller, of the first turning conveying device and at least one conveyor roller, in particular the at least one motor roller, of the second turning conveying device are equipped with a brake. The brake can be configured as a braking belt, for example, which is arranged at a bottom side of the conveyor rollers and can be adjusted against the conveyor rollers in order to avoid an undesired rotating and/or cause a braking.

To clamp the containers between the first and second conveying planes for turning, it can be provided that the clamping device has an adjusting mechanism, wherein the first turning conveying device and the second turning conveying device are mounted at the pivoting frame so as to be movable relative to each other by the adjusting mechanism, so that a normal distance between the first and second conveying planes is variable. The containers, in particular turning pairs, can thus be clamped between the first conveying plane and the second conveying plane for turning by adjusting the turning conveying devices at opposite sides of the containers and/or of the turning pair. It can be provided here that the first turning conveying device is rigidly connected to the pivoting frame and the second turning conveying device is movably mounted at the pivoting frame, the first turning conveying device is movably mounted at the pivoting frame and the second turning conveying device is rigidly connected to the pivoting frame, or the first and second turning conveying devices are movably mounted at the pivoting frame.

It is advantageously provided that the adjusting mechanism has an actuating drive, using which the first turning conveying device and/or the second turning conveying device are movable along the clamping direction, in particular in clamping direction and opposite the clamping direction.

In the method for turning containers, it is advantageous if the first and second turning conveying devices are moved relative to each other along a clamping direction by the adjusting mechanism in step c), whereby the normal distance between the first and second conveying planes is reduced until the second conveying plane is positioned against the bottom of the receiving container of the turning pair in order to clamp the turning pair between the first and second conveying planes and fix the turning pair during the turning in step d). Furthermore, it is advantageous if the first and second turning conveying devices are moved relative to each other along the clamping direction by the adjusting mechanism in step e), whereby the normal distance between the first and second conveying planes is enlarged in order to release a fixing of the turning pair. Here, the turning pair is essentially transferred to the second turning conveying device and the receiving container is deposited with its bottom on the second conveying plane.

Alternatively, it can be provided that the first and second turning conveying devices are rigidly connected to the pivoting frame. This enables a structure of the container manipulation unit to be designed in a simplified manner. Here, the first and second turning conveying devices are preferably arranged between the first and second conveying planes at a defined, in particular invariable, normal distance.

To fix the containers, in particular the turning pair, during the turning, it can be provided that the clamping device comprises at least one clamping element, which is movable along a clamping direction between an initial position of the clamping element, which is retracted in relation to the second conveying plane, and a clamped position of the clamping element, which protrudes (toward the first conveying plane) in relation to the second conveying plane. This enables containers to be clamped between the clamping element and the first turning conveying device. Particularly preferably, the at least one clamping element is arranged between two (adjacent) conveyor rollers of the second turning conveying device.

Furthermore, it can be provided that the clamping device comprises at least one other clamping element, which is movable along the clamping direction between an initial position of the other clamping element, which is retracted in relation to the first conveying plane, and a clamped position of the other clamping element, which protrudes (toward the second conveying plane) in relation to the first conveying plane. This ensures that a container to be turned, in particular the turning pair, can be clamped and fixed between the other clamping element and the second turning conveying device during the turning. A rotating back between two consecutive turning operations is thus not required as the container manipulation unit is structured to be essentially rotationally symmetric. Particularly preferably, the at least one other clamping element is arranged between two (adjacent) conveyor rollers of the first turning conveying device.

The clamping direction extends preferably orthogonally to the second conveying plane, in particular from the second conveying plane toward the first conveying plane.

It is favorable if a number of clamping elements and/or other clamping elements is greater than or equal to a maximum number of turning pairs which can be received by the container manipulation unit. This means that, if the turning device can receive a maximum of three turning pairs, for example, it is favorable if also at least three clamping elements and/or three other clamping elements are provided.

In the method for turning containers, it is preferably provided that the at least one clamping element is moved from the initial position to the clamped position in step c) in order to clamp the turning pair between the at least one clamping element and the first conveying plane and fix the turning pair during the turning in step d), and the at least one clamping element is moved from the clamped position along the clamping direction to the initial position in step e), wherein the turning pair is lowered and transferred onto the second conveying plane. Analogously, a subsequent turning operation can be executed by the other clamping unit.

It is also advantageous if the (other) clamping elements assigned to the first and/or second turning conveying device are movable individually. In this manner, differences in the height of a container or turning pair can be easily compensated for. The proposed measures are in particular also of advantage whenever a plurality of containers or turning pairs are received in the container manipulation unit simultaneously and subsequently turned as differences in the height of multiple containers or turning pairs can also be easily compensated for by the individually movable (other) clamping elements. Within the scope of this disclosure, “individually movable” shall mean in particular sprung clamping elements which, while being jointly driven, can adapt to the shape of the container, turning pair, or of the containers, turning pairs due to the spring system.

For example, the clamping elements can be individually movable such that a first one of the (other) clamping elements fixes a first one of the multiple containers in step c) and releases the first one of the multiple containers in step e) and a second one of the (other) clamping elements fixes a second one of the multiple containers in step c) and releases the second one of the multiple containers in step e).

It is of advantage if the container manipulation unit is configured for simultaneously receiving multiple containers, in particular multiple turning pairs, and the rotating device is configured for simultaneously turning the containers, in particular multiple turning pairs.

A turning pair comprises a transferring container and a receiving container put over the transferring container. The container manipulation unit comprises a first receiving position and a second receiving position between the first and second turning conveying devices, wherein a first receiving position is configured for a first one of the multiple containers, in particular for a first turning pair of multiple turning pairs, and a second receiving position is configured for a second one of the multiple containers, in particular for a second turning pair of multiple turning pairs. The container manipulation unit can additionally comprise a third receiving position between the first and second turning conveying devices, wherein a third receiving position is configured for a third one of the multiple containers, in particular for a third turning pair of multiple turning pairs. According to one possible embodiment, the first receiving position and second receiving position, and optionally the third receiving position, can be configured along the first and second turning conveying devices and in particular arranged one behind the other. Accordingly, it is also of advantage if the clamping device comprises multiple individually movable clamping elements, wherein a first one of the clamping elements is assigned to a first receiving position for a first one of the multiple containers, in particular for a first turning pair of multiple turning pairs, and a second one of the clamping elements is assigned to a second receiving position for a second one of the multiple containers, in particular for a second turning pair of multiple turning pairs and/or comprises multiple individually movable other clamping elements, wherein a first one of the other clamping elements is assigned to a first receiving position for a first one of the multiple containers, in particular for a first turning pair of multiple turning pairs, and a second one of the other clamping elements is assigned to a second receiving position for a second one of the multiple containers, in particular for a second turning pair of multiple turning pairs.

To avoid an inadvertent moving of the containers, in particular of the turning pair, out of the container manipulation unit, it is advantageous if the container manipulation unit further comprises a, in particular activatable and deactivatable, securing system for limiting a displacement movement of the containers, in particular along the first and/or second turning conveying device when the containers are positioned between the first turning conveying device and second turning conveying device for turning.

It is favorable if the securing system is activated in step c) and deactivated in step e). Here, it can be provided that the fixing of the containers and an activation of the securing system are executed in step c) so as to overlap in time, simultaneously or in succession. Here, it can in particular be provided that the fixing is begun and/or induced at a first point in time and the activation takes place at a subsequent second point in time. Alternatively, it can be provided that the activation takes place at the first point in time and the fixing is begun and/or induced at the subsequent second point in time. Analogously, it can be provided that the transferring of the turning pair and a deactivation of the securing system in step e) are executed so as to overlap in time, simultaneously or in succession. Here, it can in particular be provided that the transferring is begun, induced and/or executed at a first point in time and the deactivation takes place at a subsequent second point in time. Alternatively, it can be provided that the deactivation takes place at the first point in time and the transferring is begun, induced and/or executed at the subsequent second point in time.

The securing system comprises preferably two stop elements which are assigned to the first turning conveying device, and/or preferably two stop elements which are assigned to the second turning conveying device.

The stop elements which are assigned to the first turning conveying device and/or which are assigned to the second turning conveying device are preferably moved to the securing position before the turning of the containers, in particular of the turning pair or of the plurality of turning pairs, by rotating the container manipulation unit about a horizontal axis of rotation (R).

After turning the containers, in particular the turning pair or the plurality of turning pairs, by rotating the container manipulation unit about a horizontal axis of rotation (R), the stop elements which are assigned to the first turning conveying device and/or which are assigned to the second turning conveying device can be moved to the initial position.

The stop elements assigned to the first turning conveying device can be arranged at opposite ends of the first turning conveying device and movably mounted between an initial position, which is retracted in relation to the first conveying plane, and a securing position, which protrudes (toward the second conveying plane) in relation to the first conveying plane. In the retracted initial position, the containers and/or the turning pair is movable past the stop element along the first turning conveying device. In the securing position, the displacement of the containers and/or of the turning pair along the first turning conveying device is limited, in particular by the stop elements.

Analogously, the stop elements assigned to the second turning conveying device can be arranged at opposite ends of the second turning conveying device and movably mounted between an initial position, which is retracted in relation to the second conveying plane, and a securing position, which protrudes (toward the first conveying plane) in relation to the second conveying plane. In the retracted initial position, the containers are movable past the stop element along the first turning conveying device. In the extended securing position, the displacement of the containers along the first turning conveying device is limited, in particular by the stop elements.

In the securing position, the stop elements limit a displacement of the containers along the first and second turning conveying devices, whereas in the initial position, a movement of the containers along the first and second turning conveying devices past the stop elements is enabled. This means that, in the securing position, a turning pair is held securely in the turning device also during turning.

It is advantageous if the stop elements assigned to the first turning conveying device and/or the stop elements assigned to the second turning conveying device are moved from the initial position to the securing position to activate the securing system and from the securing position to the initial position to deactivate the securing system.

The proposed measures are in particular also of advantage whenever a plurality of turning pairs are received in the turning device simultaneously and subsequently turned as the stop elements enable also turning pairs located outside the axis of rotation, upon which high centrifugal forces act sometimes during turning, to be securely held in the turning device.

To provision a mobile turning device, it can be provided that the turning device comprises a driverless transport vehicle, for example an AMR or an AGV, wherein the support structure is arranged at the driverless transport vehicle.

The other object is achieved with a method of the kind mentioned in the beginning, wherein the method comprises the following steps:
i) provisioning a transferring container containing an article by a first provisioning device,
ii) provisioning a receiving container by a second provisioning device,
iii) putting the receiving container over the transferring container, wherein a turning pair is formed, which comprises the transferring container and the receiving container put over the transferring container,
iv) turning the turning pair by an automatic turning device,
v) provisioning the turning pair at a removal station and removing the transferring container from the receiving container by an automatic removal device.

Here, the transferring container is provisioned in the upright orientation, in particular described above, in step i). The first provisioning device can form a provisioning plane, on which the transferring container is provisioned. Further, the receiving container is provisioned in the upside-down orientation, in particular described above, by a second provisioning device in step ii). The second provisioning device can form a provisioning plane, on which the receiving container is provisioned.

The putting-over in step iii) is executed by an automatic put-over device such that the transferring container is arranged at least partially in the receiving container. Furthermore, the receiving container of the turning pair is brought to the upright orientation and the transferring container of the turning pair is brought to the upside-down orientation during the turning in step iv). The transferring container remains in the receiving container here. The article is thus essentially tipped out of the transferring container into the receiving container. To that end, the turning device is configured preferably according to one of the aspects described above.

In step v), the article is transferred to the receiving container by removing, for example pulling out upwardly, the transferring container from the receiving container. The article is thus transferred from the transferring container to the receiving container in a simple manner. The method is preferably executed with a transfer device according to one of the aspects described below.

Furthermore, the other object is achieved with a transfer device of the kind mentioned in the beginning, wherein the transfer device further comprises a put-over station with an automatic put-over device and a removal station with an automatic removal device.

The first provisioning device is configured for provisioning transferring containers in the upright orientation at the put-over station. The second provisioning device is further configured for provisioning receiving containers in the upside-down orientation at the put-over station.

What is more, the put-over device is configured for receiving receiving containers provisioned at the put-over device and putting the receiving containers over transferring containers provisioned at the put-over device in order to form turning pairs from one transferring container along with a receiving container put over the transferring container, respectively.

Furthermore, the turning device is configured for taking over turning pairs from the put-over station, turning the turning pairs, so that the receiving container is aligned in the upright orientation and the transferring container is aligned in the upside-down orientation, and handing the turning pairs over to the removal station.

Here, the removal device is configured for removing transferring containers from receiving containers.

One advantage achieved with the method according to the disclosure and the device according to the disclosure is in particular that the transfer of an article takes place in a simple manner by forming and subsequently turning the turning pair, whereby the transfer can be executed efficiently, reliably and quickly. Furthermore, the article is located in either one of the containers at any point in time of the transfer and are thus protected and secured by the transferring container and/or the receiving container at all times. This enables a particularly careful handling of the article. Furthermore, also the article which comprises a plurality of in particular small items can be transferred reliably and losslessly.

It is advantageous if the transferring container is transported to the put-over station by a transferring container conveying device in step i) and/or the receiving container is transported to the put-over station by a receiving container conveying device in step ii). This enables an automatic transport of the containers.

To that end, it can be provided that the first provisioning device comprises a transferring container conveying device for transporting the transferring containers to the put-over station and/or the second provisioning device comprises a receiving container conveying device for transporting the receiving containers to the put-over station. It is favorable if the transferring container conveying device and/or the receiving container conveying device each form a conveying plane, on which the respective containers can be transported. Particularly preferably, the transferring container conveying device is configured as a roller conveyor. The receiving container conveying device comprises preferably a roller conveyor and/or a belt conveyor.

To provision the receiving container in the upside-down orientation, it can be provided that the receiving container is transferred to the receiving container conveying device already in the upside-down orientation. This can take place in a manual or automated manner.

However, it is advantageous if the receiving container rests with its bottom on the conveying plane as this ensures a particularly reliable transport on a roller conveyor. The receiving container is therefore preferably first transported in the upright orientation and flipped into the upside-down orientation only just upstream of the put-over station.

It is thus favorable if the receiving container is transported to a container flipper of the transfer device in the upright orientation in step ii), subsequently flipped and thereby brought to the upside-down orientation by the container flipper, and finally transported from the container flipper to the put-over station.

It is preferably provided that the receiving container conveying device comprises a first conveying section for transporting the receiving container to the container flipper and a second conveying section for transporting the receiving container from the container flipper to the put-over station.

It is further favorable if the second provisioning device has a container flipper, which is configured for flipping a receiving container provisioned at the container flipper in upright orientation in order to bring the receiving container to the upside-down orientation.

The receiving container can thus be transported in the upright orientation to the container flipper of the transfer device in step ii) and flipped by the container flipper in the first conveying section of the receiving container conveying device, wherein the receiving container is brought to the upside-down orientation. Subsequently, the receiving container can be transported from the container flipper to the put-over station in the second conveying section of the receiving container conveying device. One advantage thus achieved is in particular that a major share of the transport of the receiving container can take place in upright orientation, wherein the receiving container rests stably with its bottom, and thus with a large surface, on conveying devices, and a reliable transport is thereby ensured.

Advantageously, it is provided that the first conveying section of the receiving container provisioning device is configured for handing over the receiving container to the container flipper and/or the second conveying section of the receiving container provisioning device is configured for taking over the receiving container from the container flipper.

The first and second conveying sections can be configured identically, for example as belt conveyors or roller conveyors. It is advantageously provided that the first conveying section is provisioned by a roller conveyor and the second conveying section is provisioned by a belt conveyor, in particular a dual track belt conveyor. This enables a particularly reliable transport of the receiving container as it is avoided that the receiving container in the upside-down orientation gets caught with top edges of its side walls between conveyor rollers of the roller conveyor.

It can be provided that the container flipper comprises a robot unit and/or a turning device. The turning device can in particular be configured according to one of the aspects described above.

To flip receiving containers while making use of a gravitational force, it is preferably provided that the first conveying section is arranged on a upper height level and the second conveying section is arranged on a lower height level, in particular on top of each other. The container flipper comprises preferably a chute that is arched, in particular C-shaped, at least in sections with a sliding surface, wherein the chute extends from the upper height level to the lower height level and a lower end of the chute adjoins the second conveying section.

It is expedient if the first conveying section is configured for transferring the receiving container onto the chute and/or the second conveying section is configured for taking over the receiving container from the chute.

It is advantageous if the container flipper has a tipping edge, which is arranged at an end of the first conveying section facing the chute and adjoins the first conveying section, and the sliding surface is arranged spaced apart from the tipping edge, in particular parallel to it. The tipping edge can be formed by an end piece of the first conveying section, for example.

It is favorable if the receiving container is tipped about the tipping edge and transferred onto the chute in step ii), so that the receiving container at least partially rests with top edges of side walls of the receiving container on the sliding surface, and is moved along the chute to the second conveying section and transferred to the second conveying section, wherein the receiving container is brought to the upside-down orientation.

To guide the receiving container along the chute, it can be provided that the container flipper comprises two mutually opposite lateral guides, which protrude down from the sliding surface toward the first conveying section and limit the sliding surface laterally. Preferably, the container flipper comprises a shaft, through which the receiving container can slide, wherein a bottom wall of the shaft is formed by the chute and side walls of the shaft are formed by the lateral guides.

Furthermore, it is favorable if the container flipper comprises a guide element, which is arranged opposite the sliding surface, preferably so as to extend parallel to the sliding surface, in order to guide the receiving container along the chute. The guide element can form a cover wall of the shaft opposite the bottom wall, for example.

To guide the receiving container through the container flipper in a time-phased manner, it can be provided that the container flipper comprises a stopping device, which is configured for stopping the receiving container along a sliding path, which leads along the chute from an upper end of the chute to a lower end of the chute, wherein the stopping device comprises a first catch arm, which is arranged between the upper end of the chute and the lower end of the chute and is adjustable between a catch position and a release position. This enables a receiving container to be already transferred to the container flipper, although a lower end of the chute or an exit of the container flipper is still occupied by a preceding receiving container. In the catch position, the first catch arm has been moved into the sliding path, so that the sliding path is blocked. This means that the receiving container cannot pass the catch arm and is thus stopped. In the release position, the first catch arm has been moved out of the sliding path, so that the sliding path is free. The receiving container is thus released by adjusting the catch arm from the catch position to the release position.

Furthermore, it is preferably provided that the stopping device comprises a second catch arm, which is arranged between the upper end of the chute and the first catch arm and is adjustable between a catch position, in which the second catch arm has been moved into the sliding path, and a release position, in which the second catch arm has been moved out of the sliding path.

The receiving container can thus be stopped at different locations along the sliding path. Optionally, also two receiving containers can be stopped along the sliding path, namely one by the first catch arm and one by the second catch arm. Preferably, the first catch arm and the second catch arm are spaced apart such that (precisely) one receiving container can be received between them.

It can further be provided that the first catch arm and the second catch arm are coupled with each other, in particular by a coupling mechanism, such that the second catch arm is moved to the release position when the first catch arm is moved to the catch position, and the second catch arm is moved to the catch position when the first catch arm is moved to the release position. This enables a receiving container to be moved along the chute essentially in stages, namely first from the first conveying section to the second catch arm, then from the second catch arm to the first catch arm and subsequently from the first catch arm to the second conveying section. This enables multiple receiving containers to be moved along the chute one behind the other in a time-phased manner, whereby a throughput of the container flipper is increased. A coupling can be software-based, for example. Alternatively, also a mechanical coupling mechanism can be provided.

Particularly preferably, the first and second catch arms are rigidly connected to a drive shaft and form essentially a rocker, which is mounted so as to be pivotable about an axis of rotation extending along the drive shaft. The axis of rotation is preferably aligned parallel to the sliding surface. Here, it can be provided that the first and second catch arms enclose an angle, in particular an angle of at least 90°, preferably of at least 120°, in particular approximately 135°. This ensures that the second catch arm automatically moves to the release position during deflection of the first catch arm to the catch position and vice versa.

A putting-over, i.e. the putting of the receiving container over the transferring container, is executed at the put-over station by an automatic put-over device.

Preferably, it is provided that the put-over device comprises a put-over robot unit, which is configured for receiving receiving containers and moving receiving containers in space in order to put receiving containers over transferring containers.

It is favorable if the receiving container is aligned above the transferring container by the put-over device, in particular by the put-over robot unit, and lowered such that the receiving container is put (in a collision-free manner) over the transferring container in step iii), wherein the transferring container is received in the receiving container.

It is preferably provided that the put-over station comprises a transferring container provisioning conveyor for provisioning the transferring containers at the put-over device and/or a receiving container provisioning conveyor for provisioning the receiving containers at the put-over device. The transferring container provisioning conveyor is preferably configured as a roller conveyor. Advantageously, the receiving container provisioning conveyor is configured as a belt conveyor in order to avoid that the receiving container gets caught, as described above.

The transferring container provisioning conveyor can in particular adjoin or be formed by the transferring container conveying device. Analogously, the receiving container provisioning conveyor can adjoin or be formed by the receiving container conveying device.

It is advantageous if the transferring container provisioning conveyor and/or the receiving container provisioning conveyor each form a conveying plane and each comprise at least one positioning element, which is movable between an initial position of the positioning elements, which is retracted in relation to the conveying plane, and a stop position, which protrudes in relation to the conveying plane. The positioning elements can be configured as stop elements, against which the respective containers can be positioned. This enables transferring containers and receiving containers to be precisely positioned in conveying direction of the respective provisioning conveyor.

The positioning elements can be arranged in particular such that they can be moved from the initial position to the stop position between two adjacent conveyor rollers of the respective provisioning conveyor. If the provisioning conveyor, in particular the receiving container provisioning conveyor, comprises a belt conveyor, it is preferably provided that the belt conveyor is configured as a dual track belt conveyor with two conveyor belts which extend in parallel and spaced apart from each other. It can thus be provided that the positioning elements are arranged such that they can be moved from the initial position to the stop position between the parallel conveyor belts.

To position the containers orthogonally to the respective conveying direction, it is preferably provided that the put-over station comprises an alignment device which has horizontally extendable pushing elements for sliding the transferring containers on the transferring container provisioning conveyor and/or horizontally extendable pushing elements for sliding the receiving containers on the receiving container provisioning conveyor.

Furthermore, it is advantageous if the put-over device comprises a gripping unit, which is configured for receiving at least one receiving container.

Here, it can be provided that the gripping unit of the put-over device comprises a suction gripper, a clamp gripper and/or a gripper operating in a form-fitting manner. This enables the receiving container, in particular a case, to be reliably gripped and lifted. The gripper operating in a form-fitting manner can comprise, for example, a plurality of pins, which cooperate in a form-fitting manner with projections, depressions, recesses and/or holes in or at the receiving container in order to lift the receiving container.

It is further favorable if the gripping unit of the put-over device is configured for receiving a plurality of receiving containers, in particular for receiving two, three or four receiving containers. Multiple receiving containers can thus be put over multiple transferring containers simultaneously, whereby a cycle time of the transfer device is shortened and a throughput increased.

It is favorable if side walls of the transferring container are each pressed toward a respective opposite side wall by pressing elements when putting the receiving container over the transferring container in order to center the transferring container in the receiving container. This enables an optionally occurring bulge of the transferring container to be pushed in and thus an opening of the transferring container to be reduced and/or squeezed such that there is sufficient space for the opening in the receiving container.

To that end, it can be provided that the gripping unit has multiple pressing elements, in particular pressing elements that are movable and/or form a funnel, which are adjustable to side walls of the transferring container in order to center the transferring container relative to and/or in the receiving container when putting the receiving container over the transferring container. Preferably, the pressing elements are arranged in mutually opposite pairs, so that the pressing elements are adjustable to opposite side walls of the transferring container. Particularly preferably, the gripping unit therefore comprises two or four pressing elements.

It is favorable if the pressing elements are moved from a (moved-apart) initial position, in which opposite pressing elements have been moved away from each other, to a (moved-together) press position, in which opposite pressing elements have been moved toward each other. In the press position, a distance between opposite pressing elements is preferably equal to or smaller than a distance between opposite side walls, to which the pressing elements are to be adjusted. To that end, the distance is measured preferably at those points of the opposite pressing elements which are located closest to each other in the press position. It is advantageous if the pressing elements are mounted so as to be pivotable or guided by a curve guide, so that the pressing elements are movable from the initial position to the press position.

Preferably, opposite pressing elements are inclined toward each other in the press position, so that the pressing elements essentially form a funnel that tapers off upwardly.

Advantageously, the put-over device can have a trap door, through which the receiving container can be transferred downwardly. The receiving container conveying device and/or the receiving container provisioning conveyor is preferably configured for transferring receiving containers onto the trap door. Here, the transferring container provisioning conveyor can be arranged below the trap door and configured for aligning the transferring container with the trap door. The put-over device preferably comprises a, in particular vertical, shaft, which connects the trap door and the transferring container provisioning conveyor such that the receiving container can be transferred through the trap door to an upper end of the shaft and to the transferring container provisioning conveyor at a lower end of the shaft. If the transferring container provisioning conveyor provisions a transferring container at the lower end of the shaft, the receiving container is put over the transferring container during the transfer at the lower end.

It is advantageous if step iv) comprises:
turning the turning pair by rotating a container manipulation unit about a horizontal axis of rotation, wherein the turning device comprises the container manipulation unit.

This enables the turning operation to be executed in a small space.

In particular, the container manipulation unit can be configured for transporting and turning the containers and/or the turning pair.

The container manipulation unit can comprise a first turning conveying device and a second turning conveying device.

The container manipulation unit can be provisioned before step iv).

Here, it is advantageous if the first turning conveying device forms a first conveying plane and the second turning conveying device forms a second conveying plane, wherein the first conveying plane and the second conveying plane are arranged at a normal distance from each other and opposite each other. This enables the turning pair to be received and held in the turning device in a simple manner.

It is also advantageous if the first turning conveying device is equipped with at least one self-driven motor roller with a drive device and the second turning conveying device is equipped with a self-driven motor roller with a drive device. The conveyor rollers allow a transport of the turning pair inside the turning device and a reception of the turning pair in the turning device and a transfer of the turning pair from the turning device.

It is also particularly advantageous if the turning pair is fixed between the first turning conveying device and the second turning conveying device of the container manipulation unit by a clamping device of the container manipulation unit. The clamping device ensures a secure hold of the turning pair during the turning operation.

Making use of the advantages and effects described above in relation to the method for turning containers, it is preferably provided that the turning in step iv) comprises the following steps:
transporting the turning pair from the put-over station to the turning device,
handing over the turning pair to a container manipulation unit of the turning device,
turning the turning pair according to a method for turning containers according to one of the aspects described above,
handing over the turning pair to the removal station.

It is thus favorable if the turning device of the transfer device is configured according to one of the aspects described above.

In a related aspect, a method which comprises the following steps is also of advantage:
i) provisioning a transferring container containing an article in an upright orientation at a put-over station by a first provisioning device,
ii) provisioning a receiving container in an upside-down orientation at the put-over station by a second provisioning device,
iii) putting the receiving container over the transferring container by an automatic put-over device, so that the transferring container is arranged at least partially in the receiving container, wherein a turning pair is formed, which comprises the transferring container and the receiving container put over the transferring container,
iv-a) provisioning a container manipulation unit for transporting and turning the containers which comprises a first turning conveying device and a second turning conveying device, wherein the first turning conveying device forms a first conveying plane and the second turning conveying device forms a second conveying plane, wherein the first conveying plane and the second conveying plane are arranged at a normal distance from each other and opposite each other,
iv-b) transporting the turning pair from the put-over station to the turning device,
iv-c) handing over the turning pair, comprising the transferring container and the receiving container put over the transferring container, to the container manipulation unit between the first turning conveying device and the second turning conveying device by depositing the transferring container with its bottom on the first conveying plane,
iv-d) optionally fixing the turning pair between the first turning conveying device and the second turning conveying device of the container manipulation unit, in particular by a clamping device of the container manipulation unit,
iv-e) rotating the container manipulation unit about a horizontal axis of rotation and turning the turning pair, in particular with the help of a rotating device of the turning device,
iv-f) transferring the turning pair to the second turning conveying device, wherein the receiving container of the turning pair is deposited with its bottom on the second conveying plane,
iv-g) in case of step iv-d) detaching or releasing the turning pair by the clamping device,
iv-h) transporting the turning pair out of the container manipulation unit,
iv-i) handing over the turning pair to the removal station,
v) removing the transferring container from the receiving container by an automatic removal device, wherein the article is transferred to the receiving container.

It is favorable in this context if
the first turning conveying device of the container manipulation unit provisioned in step iv-a) comprises at least one self-driven motor roller with a drive device and the second turning conveying device of the container manipulation unit provisioned in step iv-a) comprises a self-driven motor roller with a drive device,
the at least one motor roller of the first turning conveying device is driven by its drive device in order to position the turning pair in the container manipulation unit in step iv-c),
the turning pair is transported out of the container manipulation unit in step iv-h) by driving the at least one motor roller of the second turning conveying device by its drive device.

The embodiments and advantages already mentioned in relation to this aspect analogously apply here. In particular, step iv-g) may also be executed before step iv-f).

It is advantageously provided that the first provisioning device, in particular the transferring container provisioning conveyor, forms a main conveying plane, and the turning device is adjustable between a first and second configuration, wherein the first conveying plane of the turning device is in alignment with the main conveying plane in the first configuration and the second conveying plane of the turning device is in alignment with the main conveying plane in the second configuration.

It is preferably provided that the removal station comprises a first removal conveying device for taking over turning pairs from the turning device, for provisioning the turning pairs at the removal device and for transporting the receiving containers away from the turning device and optionally a second removal conveying device for taking over transferring containers from the removal device and for transporting the transferring containers away from the turning device. The first and/or second removal conveying devices can each be configured as a roller conveyor or belt conveyor.

To position the turning pairs at the removal device, it can be provided that the first removal conveying device forms a conveying plane and comprises at least one positioning element, which is movable between an initial position, which is retracted in relation to the conveying plane, and a stop position, which protrudes in relation to the conveying plane. Here, the positioning elements of the first removal conveying device can be configured analogously to the positioning elements of the provisioning conveyor described above.

Furthermore, it is favorable if the removal station comprises an alignment device, which is configured in particular analogously to the alignment device of the put-over station described above. Preferably, the alignment device has horizontally extendable pushing elements for sliding the turning pairs on the first removal conveying device.

Preferably, it is provided that the removing of the transferring container is executed in step v) by seizing and lifting the transferring container from above by the removal device, wherein the transferring container is removed from the receiving container.

Preferably, the removal device comprises a removal robot unit, which is configured for receiving transferring containers and moving transferring containers in space in order to remove them from the receiving containers.

It is favorable if the removal device comprises a gripping unit, which is configured for receiving at least one transferring container.

Preferably, it is provided that the removal station comprises a retaining device for retaining the receiving container during the removal of the transferring container. The retaining device can be configured as a clamping device, for example. The clamping device preferably comprises opposite clamping elements that are movable toward each other and between which the receiving container can be fixed by clamping.

It is thus favorable if the receiving container is retained by the retaining device during step v).

To ensure that all items of the article are transferred from the transferring container, it can be provided that the transferring container is shaken during step v), in particular while being lifted by the removal device.

To that end, the removal device can comprise a shaking device, which is configured for shaking the transferring container. For example, the shaking device can be configured for moving the gripping unit back and forth or up and down in an oscillating manner.

Furthermore, it can be provided that the removal station comprises a checking device, which is configured for examining whether the transferring container is empty after a removal of the transferring container from the receiving container. To that end, the checking device can have a sensor system for detecting an article in an interior of the transferring container, for example. The sensor system can in particular comprise an ultrasonic sensor, a distance sensor or a camera for capturing an image of the interior of the transferring container. Furthermore, the checking device can have a data processing unit, which evaluates an image captured by the camera, in particular using an algorithm for object recognition in order to identify an article. If no article is identified, it can be confirmed that the transferring container has been emptied completely.

It is favorable if the checking device is arranged between the first and second removal conveying devices. The transferring container can thus be moved across the checking device above the checking device, and an interior of the transferring container can be detected.

In the method described, it is thus preferably provided that it is examined by the checking device whether the transferring container is empty after the removal of the transferring container from the receiving container.

Here, it can in particular be provided that the transferring container is moved across the checking device at a defined distance and the checking device has a distance sensor, using which a distance between the checking device and the bottom of the transferring container is detected. In this way, the measured distance can be matched against a target distance, for example, which results from the defined distance at which the transferring container is moved. If the measured distance is shorter, this may indicate a remaining article in the transferring container. The transferring container can then be transported to a troubleshooting workstation by the second removal conveying device, for example.

To be able to execute the method particularly efficiently, it is advantageous if a plurality of transferring containers, in particular three transferring containers, are provisioned in step i) and a plurality of receiving containers, in particular three receiving containers, are provisioned in step ii). Here, a number of provisioned transferring containers preferably corresponds to a number of provisioned receiving containers. Furthermore, it is favorable if step iii) is executed for the provisioned transferring containers and receiving containers simultaneously, wherein one receiving container is put over one transferring container, respectively, in order to form a plurality of turning pairs, in particular three turning pairs, and/or step iv) (in particular step iv-e) is executed for the turning pairs formed in step iii) simultaneously and/or step v) is executed for the turning pairs turned in step iv) simultaneously. In this context, also individually movable clamping elements are of particular advantage.

Making use of the advantages and effects described above, the object is further achieved with an order picking warehouse of the kind mentioned in the beginning, wherein the transfer device is configured according to one of the aspects described above.

Preferably, it is provided that the storage conveying system adjoins the removal station of the transfer device, in particular the first removal conveying device, in terms of conveyance and/or is configured for taking over receiving containers from the removal station of the transfer device. It is expedient if the removal station, in particular the first removal conveying device, of the transfer device is configured for handing over receiving containers to the storage conveying system of the order picking warehouse.

It is favorable if the order picking warehouse comprises a supply conveying system for transporting the transferring containers to the transfer device, in particular from the article receipt to the transfer device. It is particularly advantageous if the first provisioning device of the transfer device, in particular the transferring container conveying device, adjoins the supply conveying system in terms of conveyance and/or is configured for taking over transferring containers from the supply conveying system. It is expedient if the supply conveying system is configured for handing over transferring containers to the first provisioning device, in particular to the transferring container conveying device, of the transfer device.

Furthermore, the order picking warehouse can comprise a picking conveying system, which connects the article storage and the picking station in terms of conveyance, a shipping conveying system for transporting shipping containers, which connects the picking station to an article issue of the order picking warehouse in terms of conveyance, and/or an empties conveying system for transporting empty receiving containers to the transfer device.

The conveying devices of the transfer device described above, in particular the transferring container conveying device, the receiving container conveying device, the first removal conveying device and/or the second removal conveying device, and the conveying systems described in relation to the order picking warehouse, in particular the supply conveying system, the storage conveying system, the picking conveying system, the shipping conveying system and/or the empties conveying system, can each comprise a stationary conveying device and/or a mobile conveying device. On the one hand, the stationary conveying device can comprise a continuous conveyor, for example a roller conveyor and/or a belt conveyor. On the other hand, the mobile conveying device can comprise a non-continuous conveyor, for example a driverless transport system. The driverless transport system can comprise a plurality of driverless transport vehicles, in particular automatically guided transport vehicles, so-called “automated guided vehicles” (AGVs in short) and/or autonomously displaceable transport vehicles, so-called “autonomous mobile robots” (AMRs in short).

Preferably, the conveying devices each form a conveying plane on which containers rest and can be transported. These conveying planes can be provisioned, for example, by conveyor rollers of a roller conveyor, by a conveyor belt of a belt conveyor, by a receiving platform of a transport vehicle or suchlike.

For the purpose of better understanding of the disclosure, it will be elucidated in more detail by means of the figures below.

### BRIEF DESCRIPTION OF THE FIGURES

These show in a very simplified schematic representation:

FIGS. 1a to 1d a turning device for turning containers;

FIGS. 2a to 2c another turning device for turning containers;

FIG. 3 a motor roller;

FIG. 4 a roller group of a motor roller and multiple conveyor rollers;

FIG. 5 a transfer device for transferring an article from a transferring container to a receiving container;

FIG. 6 an enlarged detail of the transfer device;

FIGS. 7a and 7b a container flipper for flipping receiving containers;

FIGS. 8a to 8c a put-over station for forming turning pairs;

FIGS. 9a to 9d a gripping unit of a put-over device;

FIGS. 10a to 10c a removal station for separating turning pairs;

FIG. 11 an operating principle of the transfer device;

FIGS. 12a to 12e the transfer device in a top view;

FIG. 13 an order picking warehouse.

### DETAILED DESCRIPTION OF THE EMBODIMENTS

First of all, it is to be noted that, in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure, and in case of a change of position, are to be analogously transferred to the new position.

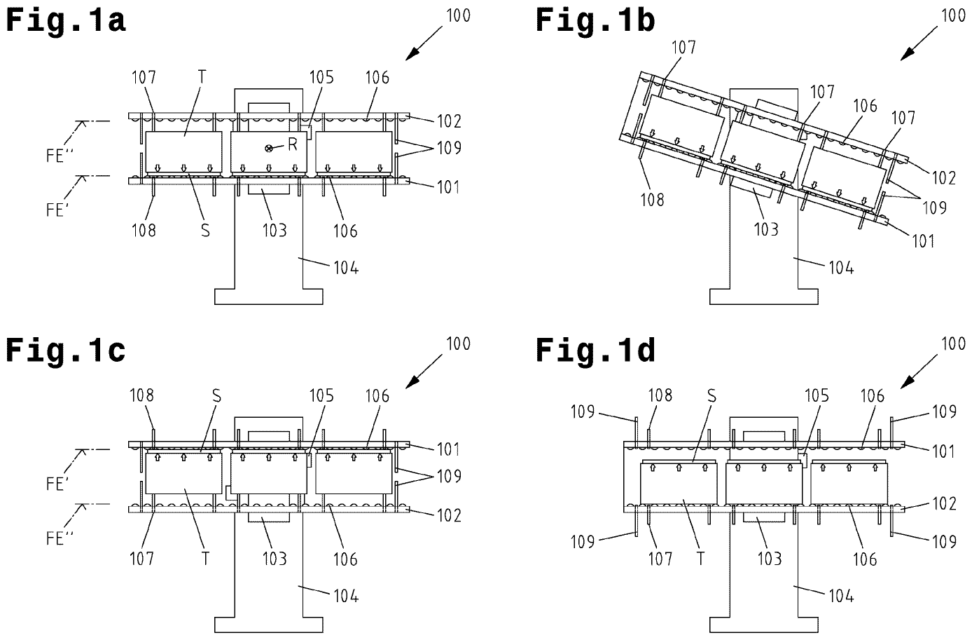

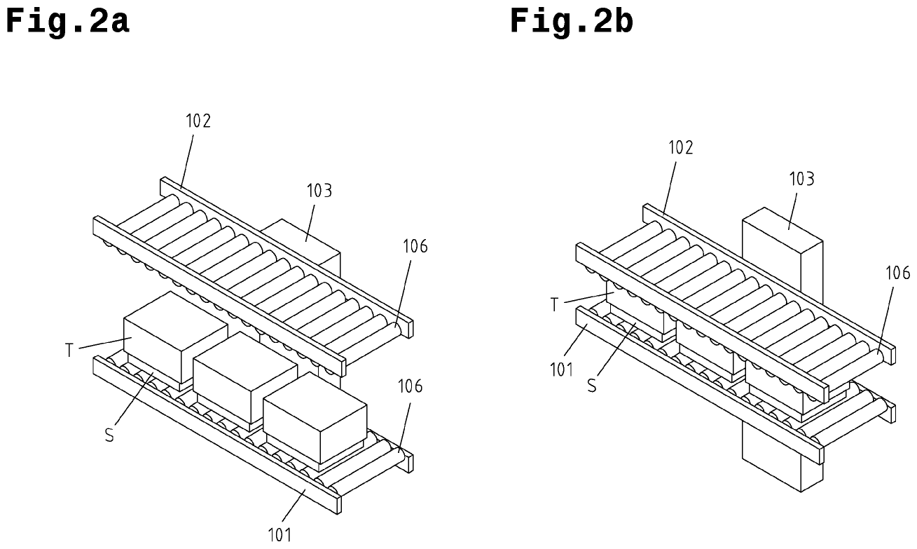

FIG. 1a to FIG. 1c and FIG. 2a to FIG. 2c show a turning device 100 for containers S, T, in particular for turning pairs, in a lateral view. As a rule, a turning pair comprises one or multiple transferring containers S and a receiving container T put over this or these transferring containers S.

To transport and turn the containers S, T, the turning device 100 comprises a container manipulation unit. The container manipulation unit has a first turning conveying device 101 and a second turning conveying device 102. Here, the first turning conveying device 101 forms a first conveying plane FE′ and the second turning conveying device 102 forms a second conveying plane FE″. As can be gleaned from FIG. 1a, the turning conveying devices 101, 102 are arranged mutually opposite with conveying planes FE′, FE″ facing each other. Furthermore, the container manipulation unit comprises an optional clamping device in order to fix the containers S, T between the first turning conveying device 101 and the second turning conveying device 102.

The turning device 100 further comprises a rotating device, which has a pivoting frame 103 and a stationary support structure 104. The pivoting frame 103 is mounted at the support structure 104 so as to be rotatable about an axis of rotation R. The first and second turning conveying devices 101, 102 are mounted at the pivoting frame 103. Preferably, the rotating device comprises a rotary drive 105, by which the pivoting frame 103 can be rotated. A rotation of the pivoting frame 103 of the rotating device therefore results in a turning of a turning pair.

Furthermore, the turning conveying devices 101, 102 each comprise a plurality of optional conveyor rollers 106. At least one conveyor roller 106 of the first turning conveying device 101 and at least one conveyor roller 106 of the second turning conveying device 102 are configured as self-driven, in particular gearless, motor rollers 106′ with a drive device.

According to one embodiment of the clamping device, it is provided that the clamping device has at least one clamping element 107 arranged between two (adjacent) conveyor rollers 106 of the second turning conveying device 102. The at least one clamping element 107 is movable along a clamping direction toward the first turning conveying device 101 in order to fix containers S, T by clamping. To that end, the at least one clamping element 107 can be moved between an initial position, which is retracted in relation to the second conveying plane FE″, and a clamped position, which protrudes toward the first conveying plane FE′ in relation to the second conveying plane FE″.

Analogously, it can be provided that the clamping device has at least one other clamping element 108, which is arranged between two (adjacent) conveyor rollers 106 of the first turning conveying device 101. The at least one other clamping element 108 is movable along the clamping direction toward the second turning conveying device 102 in order to fix containers S. T by clamping. To that end, the at least one other clamping element 108 can be moved between an initial position, which is retracted in relation to the first conveying plane FE″, and a clamped position, which protrudes toward the second conveying plane FE″ in relation to the first conveying plane FE′.

The at least one clamping element 107 is arranged in the clamped position in FIG. 1a to FIGS. 1c and 1n the initial position in FIG. 1d. The at least one other clamping element 108 is further arranged in the initial position in FIG. 1a to FIG. 1d.

Alternatively, it can be provided that the clamping device has an adjusting mechanism in order to vary a normal distance between the first conveying plane FE′ and the second conveying plane FE″. To that end, the turning conveying devices 101, 102 are mounted at the pivoting frame 103 so as to be movable relative to each other along the clamping direction by the adjusting mechanism. This is schematically represented in FIG. 2a to FIG. 2c.

As not explicitly represented, it can furthermore be provided that the clamping device has both the clamping elements 107 described above and the adjusting mechanism described.

Furthermore, the container manipulation unit can have an optional securing system with multiple stop elements 109. The stop elements 109 are arranged at both ends of the turning conveying devices 101, 102 and are movable analogously to the clamping elements 107 between an initial position, which is retracted in relation to the respective conveying plane FE′, FE″, and a securing position, which protrudes in relation to the respective conveying plane FE′, FE″. Here, the securing position essentially corresponds to the clamped position. The stop elements 109 are provisioned in the securing position in FIG. 1a to FIGS. 1c and 1n the initial position in FIG. 1d. The securing system can be provided in any and all embodiments of the clamping device, though this is not represented in FIG. 2a to FIG. 2c for reasons of clarity.

To turn one or multiple containers S, T and/or one or multiple turning pairs, these are provisioned on the first turning conveying device 101, as shown in FIG. 1a or FIG. 2a.

Subsequently, the containers S, T are fixed between the first and second turning conveying devices 101, 102. This can be executed by the clamping elements 107, as shown in FIG. 1a, or by the adjusting mechanism, as shown in FIG. 2b.

Furthermore, the containers S, T can be secured by the securing system described above by bringing the stop elements 109 to the securing position, as shown in FIG. 1a by way of example.

The container manipulation unit can now be rotated, in particular by 180°, about the axis of rotation R, whereby the containers S, T and/or the turning pairs are turned, as can be gleaned from FIG. 1b, FIG. 1c and FIG. 2c.

To release the containers S, T and/or the turning pairs after the turning, the clamping elements 107 can be retracted from the clamped position to the initial position, whereby the containers S, T are lowered onto the second conveying plane FE″, as represented in FIG. 1d. Alternatively, the turning conveying devices 101, 102 can be moved apart again by the adjusting mechanism in order to release the containers S, T and/or the turning pairs, as represented in FIG. 2c.

If the containers S, T were secured by the securing system, also the stop elements 109 can now be brought back to the initial position, as also shown in FIG. 1d by way of example.

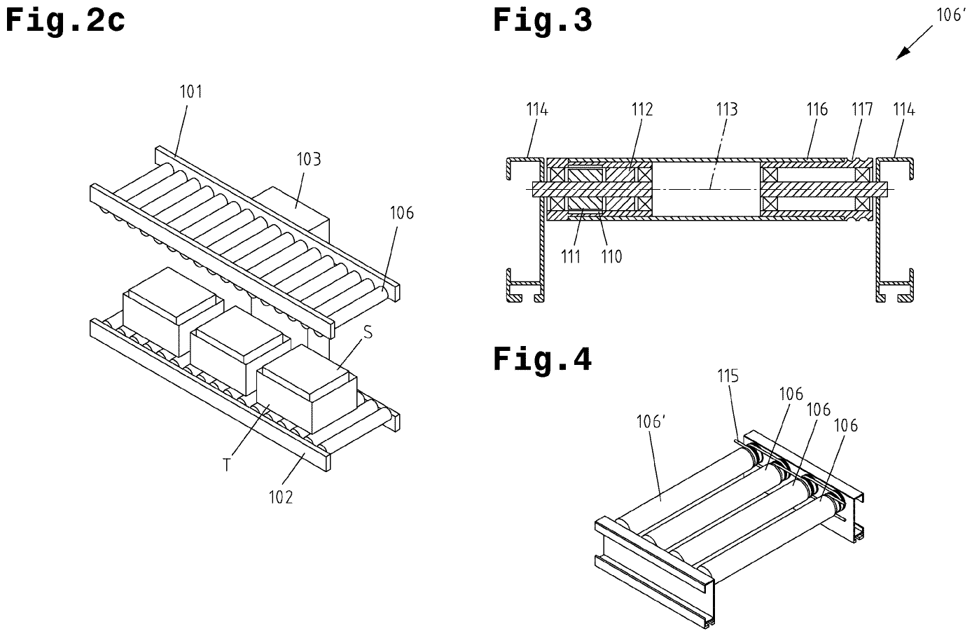

FIG. 3 shows a conveyor roller 106 of the turning device 100 configured as a motor roller 106′ in a cross-sectional representation. For reasons of better clarity, an electrical connection of the motor roller 106′ to an electrical energy supply is not represented. The motor roller comprises a roller axle 113 and a roller body mounted so as to be rotatable relative thereto 116. The drive device of the motor roller 106′ comprises an electric motor, with a rotor 110 arranged coaxially to the roller axle 113, which is (non-rotatably) connected to the roller body 116, and a stator 111 arranged coaxially to the roller axle 113. Usually, a conveyor roller 106, in particular the motor roller 106′, is rotatably mounted at opposite frame profiles 114 of the respective turning conveying device 101, 102 via the roller axle 113. Optionally, the motor roller 106′ can additionally have a brake 112. Particularly preferably, the motor roller 106′ is configured as described in WO 2016/141396 A1.

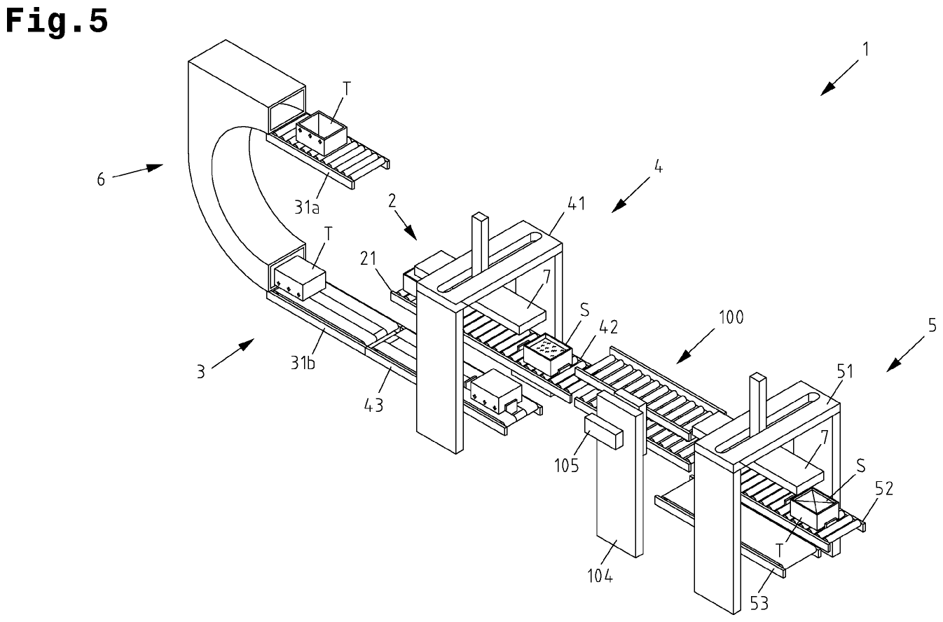

Furthermore, it can be provided that multiple conveyor rollers 106 of the first turning conveying device 101 form a roller group and/or that multiple conveyor rollers 106 of the second turning conveying device 102 form a roller group. Such a roller group is shown in FIG. 4. The roller group comprises a motor roller 106′ and multiple conveyor rollers 106. The conveyor rollers 106 are connected to the motor roller 106′ via a belt transmission 115. Belts of the belt transmission 115 can be guided in guide grooves 117 optionally provided at the conveyor rollers 106 and the motor roller 106′ to that end. Such optional guide grooves 117 are shown in FIG. 3 by way of example. The guide grooves 117 can be arranged, for example, at the roller body 116 or at a connecting part, onto which the roller body 116 is plugged.

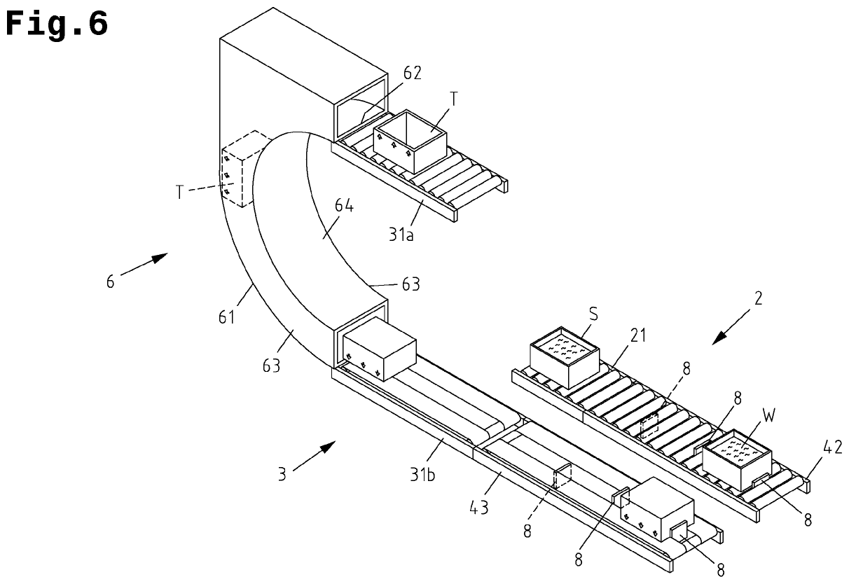

FIG. 5 shows a transfer device 1 for automatically transferring an article from a transferring container S to a receiving container T in a perspective view, wherein the transfer device 1 comprises a first provisioning device 2, a second provisioning device 3, a put-over station 4, a turning device 100 and a removal station 5.

To transport the transferring container S to the put-over station 4, it is preferably provided that the first provisioning device 2 comprises a transferring container conveying device 21. Furthermore, it is preferably provided that the second provisioning device 3 comprises a receiving container conveying device 31a, 31b.

Optionally, the second provisioning device 3 can comprise a container flipper 6, which is configured for bringing receiving containers T from the upright orientation to the upside-down orientation. Here, it is favorable if the receiving container conveying device 31a, 31b has a first conveying section 31a leading toward the container flipper 6 and a second conveying section 31b leading away from the container flipper 6.

The put-over station 4 further comprises a put-over device 41, which is configured for putting receiving containers T provisioned at the put-over station 4 over transferring containers S also provisioned at the put-over station 4 in order to form turning pairs. Here, the turning pairs are formed such that the transferring container S or transferring containers S of the respective turning pair are in upright orientation and the receiving container T of the respective turning pair is in upside-down orientation. Preferably, the put-over station 4 is arranged so as to adjoin the first provisioning device 2 and the second provisioning device 3 in terms of conveyance.

It is expedient if the put-over device 41 comprises a gripping unit 7, which is configured for gripping receiving containers T. Preferably, the put-over device 41 is configured as a gantry robot with such a gripping unit 7, as shown in FIG. 5 by way of example. Yet, alternatively, the put-over device 41 can also be configured as a jointed-arm robot with such a gripping unit 7.

The turning device 100 is configured for turning the turning pairs formed in the put-over station 4, so that the transferring containers S are in the upside-down orientation and the receiving containers T are in the upright orientation. Preferably, the turning device 100 is arranged so as to adjoin the put-over device 41 in terms of conveyance. Particularly preferably, the turning device 100 is configured according to one of the aspects described above.

Finally, the removal station 5 has a removal device 51, which is configured for removing transferring containers S from the receiving containers T, in particular in order to separate turning pairs. Preferably, the removal station 5 comprises a first removal conveying device 52, using which turning pairs can be taken over from the turning device 100 and provisioned at the removal station 5. Using the first removal conveying device 52, the receiving containers T can further be transported away from the removal device 51. Furthermore, it is favorable if the removal station 5 comprises a second removal conveying device 53, to which removed transferring containers S can be transferred and using which the transferring containers S can be transported away from the removal device 51.

It is expedient if the removal device 51 comprises a gripping unit 7, which is configured for gripping transferring containers S. Preferably, the removal device 51 is configured as a gantry robot with such a gripping unit 7, as shown in FIG. 5 by way of example. Yet, alternatively, the removal device 51 can also be configured as a jointed-arm robot with such a gripping unit 7.

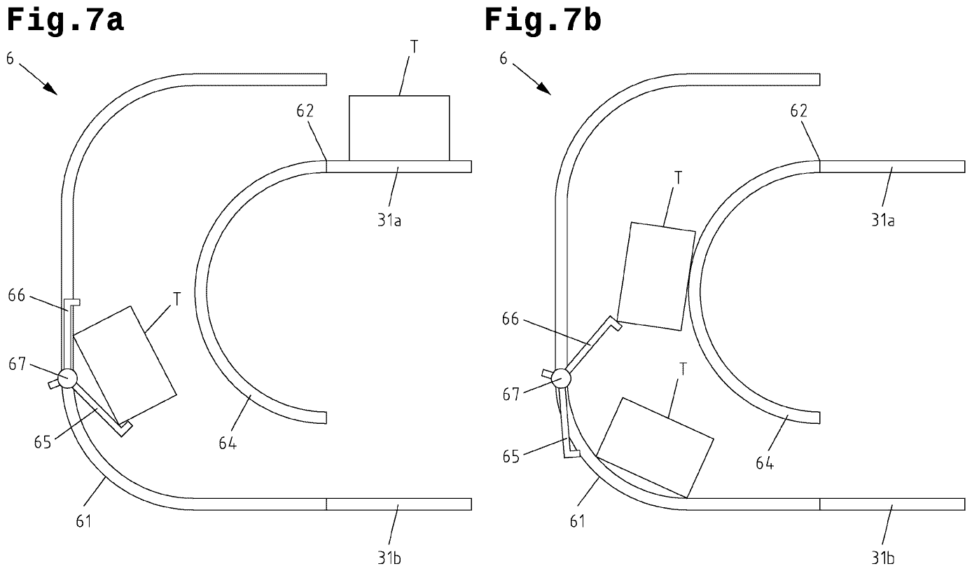

FIG. 6 shows the first and second provisioning devices 2, 3 and the put-over station 4 in an enlarged representation, wherein the put-over device 41 is not represented for reasons of clarity.

As can be seen in FIG. 6, the first conveying section 31a leads toward the container flipper 6, wherein the receiving container T is transported in upright orientation. The second conveying section 31b leads away from the container flipper 6 and toward the put-over station 4.

As represented, it can be provided that the first conveying section 31a is arranged at a upper height level and the second conveying section 31b at a lower height level. The two conveying sections 31a, 31b are preferably arranged on top of each other and facing each other.

As shown in FIG. 5 and FIG. 6, the container flipper 6 a can comprise a, in particular C-shaped, chute 61. The chute 61 extends at least partially along an arc and thus connects the first conveying section 31a with the second conveying section 31b.

The container flipper 6 can further comprise a tipping edge 62, over which the receiving container T can be tipped downward. The receiving container T can thus be transported in upright orientation to the container flipper 6 via the first conveying section 31a and transferred to the chute 61 over the tipping edge 62. Here, the container S, T is essentially tipped downward, so that the container S, T at least partially rests with its open side, in particular with top edges of side walls of the receiving container T, on a sliding surface of the chute 61, as indicated by the dashed receiving container T. The tipping edge 62 can be provisioned by an end piece of the first conveying section 31a, for example.

To limit the chute 61 laterally, the container flipper 6 can have two mutually opposite lateral guides 63.

Furthermore, the container flipper 6 can have a guide element 64, which is arranged opposite the sliding surface and guides the receiving container T along the chute 61. As can be seen in FIG. 6, the chute 61, the lateral guides 63 and the guide element 64 can essentially form a shaft, through which the receiving container T can be guided.

The receiving container T can slide downward along the chute 61, in particular making use of gravity, and be handed over to the second conveying section 31b in upside-down orientation, as indicated in FIG. 6 by a dashed receiving container T.

Furthermore, the container flipper 6 can comprise a stopping device. Preferably, the stopping device comprises a first catch arm 65, which is positioned between the upper end of the chute 61 and the lower end of the chute 61 and is adjustable between a catch position and a release position.

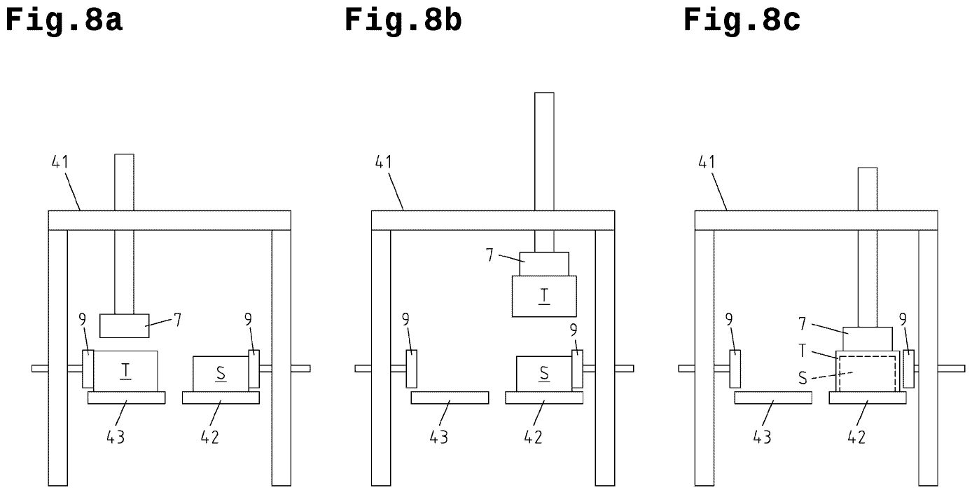

When moving the receiving container T along the chute 61, the first catch arm 65 can first be arranged in the catch position, so that the receiving container T is transferred to the container flipper 6, moved to the first catch arm 65 and stopped by the first catch arm 65, as shown in FIG. 7a by way of example. To release the receiving container T, the first catch arm 65 is moved from the catch position to the release position, the receiving container T is released and moved to the lower end of the chute 61, as shown in FIG. 7b by way of example.

To enable multiple collecting containers to be moved through the container flipper 6 in a time-phased manner, the stopping device can comprise a second catch arm 66, which is positioned between the upper end of the chute 61 and the first catch arm 65 and, like the first catch arm 65, also adjustable between a catch position and a release position.

To that end, the first catch arm 65 and the second catch arm 66 can be rigidly connected to a drive shaft 67 and thus form a rocker, which is mounted so as to be pivotable about an axis of rotation extending along the drive shaft 67, as shown in FIG. 7a and FIG. 7b. When the rocker is pivoted in a first direction, for example counter-clockwise, the first catch arm 65 is brought to the catch position and the second catch arm 66 to the release position. When the rocker is pivoted in a second direction opposite the first direction, for example clockwise, the first catch arm 65 is brought to the release position and the second catch arm 66 to the catch position.

Thus, it can be provided when turning multiple receiving containers T that the first catch arm 65 is first positioned in the catch position and the second catch arm 66 in the release position, as shown in FIG. 7a. The receiving container T can thus be transferred to the container flipper 6, moved to the first catch arm 65 and stopped by the first catch arm 65.

Subsequently, the first catch arm 65 can be brought to the release position and the second catch arm 66 to the catch position, in particular simultaneously, as shown in FIG. 7b. Here, the first receiving container T is released and moved to the lower end of the chute 61. Meanwhile, another receiving container T can already be transferred to the container flipper 6. The other receiving container T is moved along the chute 61 to the second catch arm 66 and stopped by the second catch arm 66.

When the second catch arm 66 is subsequently brought to the release position and the first catch arm 65 to the catch position, the other receiving container T is handed over to the first catch arm 65 by the second catch arm 66, as can be seen from a combination of FIG. 7b and FIG. 7a.

To provision the transferring containers S at the put-over device 41, which is not represented, the put-over station 4 can comprise a transferring container provisioning conveyor 42. Analogously, the put-over station 4 can comprise a receiving container provisioning conveyor 43 in order to provision the receiving containers T at the put-over device 41 not represented.

The transferring container provisioning conveyor 42 and the receiving container provisioning conveyor 43 can each be configured as a roller conveyor and/or as a belt conveyor. Particularly preferably, the transferring container provisioning conveyor 42 is configured as a roller conveyor and the receiving container provisioning conveyor 43 as a belt conveyor, in particular as a dual track belt conveyor with two conveyor belts which extend in parallel and spaced apart from each other, as represented in FIG. 6.

To position the transferring containers S and/or the receiving containers T at defined positions and in particular align them with each other, it can be provided that the transferring container provisioning conveyor 42 and/or the receiving container provisioning conveyor 43 each have at least one positioning element 8. For example, the provisioning conveyors represented each comprise three positioning elements 8 which are arranged downstream of one another in conveying direction. The first removal conveying device 52 can also comprise such positioning elements 8, as can be seen in FIG. 5.

As can be seen in FIG. 6, the positioning elements 8 can be moved between an initial position, which is retracted relative to a conveying plane of the respective provisioning conveyor 42, 43 or to the first removal conveying device 52 and in which the positioning elements 8 are arranged below the respective conveying plane, and a stop position, which protrudes (upward) in relation to the respective conveying plane.

In the example shown, a first positioning element 8 and a second positioning element 8 arranged upstream of the first positioning element 8 of the transferring container provisioning conveyor 42 and of the receiving container provisioning conveyor 43, respectively, are in the stop position, wherein a transferring container S and a receiving container T are positioned against the first positioning element 8 of the respective provisioning conveyor 42, 43. Furthermore, another transferring container S and another receiving container T can be positioned against the second positioning element 8 of the respective provisioning conveyor 42, 43. Finally, a third positioning element 8 arranged upstream of the respective second positioning element 8 of the transferring container provisioning conveyor 42 and of the receiving container provisioning conveyor 43, respectively, is arranged in the initial position, so that the other transferring container S or the other receiving container T can be transported past the respective third positioning element 8.

If the respective provisioning conveyor 42, 43 is configured as a belt conveyor, in particular as a dual track belt conveyor, it can be provided that the positioning elements 8 are movably arranged between the conveyor belts, as shown in FIG. 6 using the example of the receiving container provisioning conveyor 43. Alternatively, it can be provided that the positioning elements 8, as shown in FIG. 6 using the example of the transferring container provisioning conveyor 42, are movably arranged between two adjacent conveyor rollers 106 if the respective provisioning conveyor 42, 43 is configured as a roller conveyor.

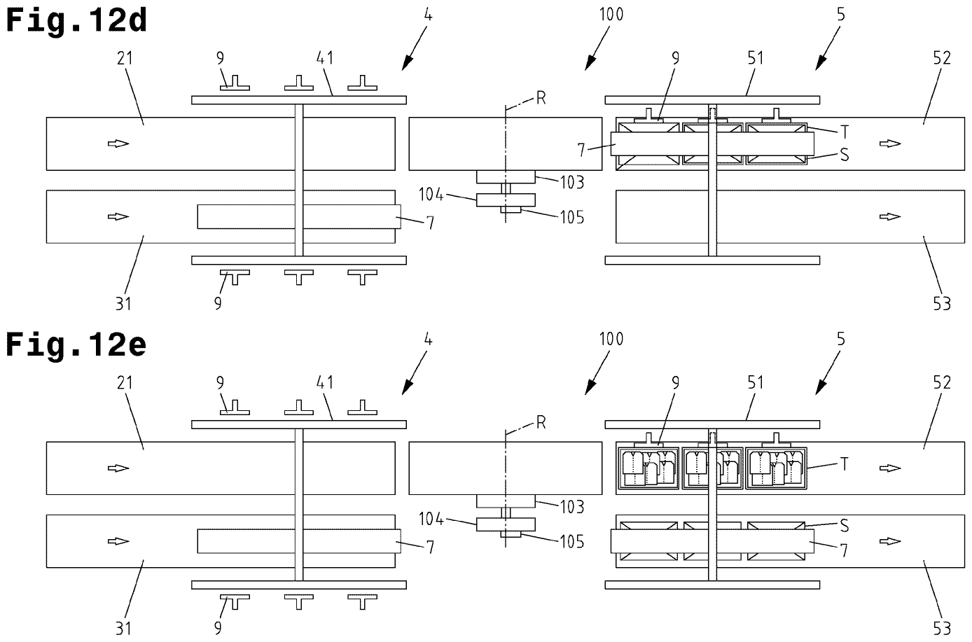

Furthermore, it can be provided that the put-over station 4 comprises an optional alignment device. The alignment device preferably comprises at least one horizontally extendable pushing element 9 for sliding the transferring containers S on the transferring container provisioning conveyor 42 and/or at least one horizontally extendable pushing element 9 for sliding the receiving containers T on the receiving container provisioning conveyor 43. As shown in FIG. 12a to FIG. 12e, also the removal station 5 can comprise such an alignment device, which has at least one horizontally extendable pushing element 9 for sliding the turning pairs on the first removal conveying device 52.

It is favorable if the transferring container conveying device 21 comprises a roller conveyor like in the example shown.

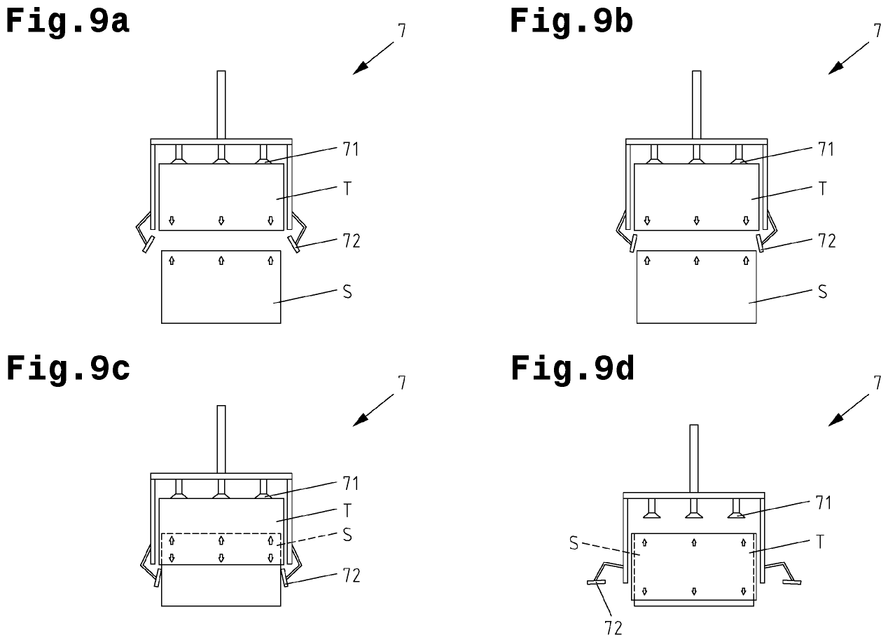

FIG. 8a to FIG. 8c show the put-over station 4 in a front view. Here, the gripping unit 7 of the put-over device 41 is configured for receiving the receiving containers T.

To execute the putting-over, transferring containers S and receiving containers T are provisioned at the put-over station 4 as described above and positioned by the positioning elements 8 not represented in FIG. 8a to FIG. 8c. Optionally, the transferring containers S and the receiving containers T are positioned horizontally by the pushing elements 9 as described above. This is represented in FIG. 8a.

To put receiving containers T over transferring containers S, the receiving containers T are received and optionally lifted by the gripping unit 7 of the put-over device 41, as can be gleaned from a combination of FIG. 8a and FIG. 8b. Subsequently, the receiving containers T are positioned above and lowered onto the transferring containers S, as can be seen in FIG. 8c. Here, the so-called turning pairs are formed.

It can be provided that the gripping unit 7 of the put-over device 41 is dimensioned such that it can receive multiple, in particular three, receiving containers T, as represented below in FIG. 12a to FIG. 12e. Multiple, in particular three, turning pairs can thus be formed simultaneously.

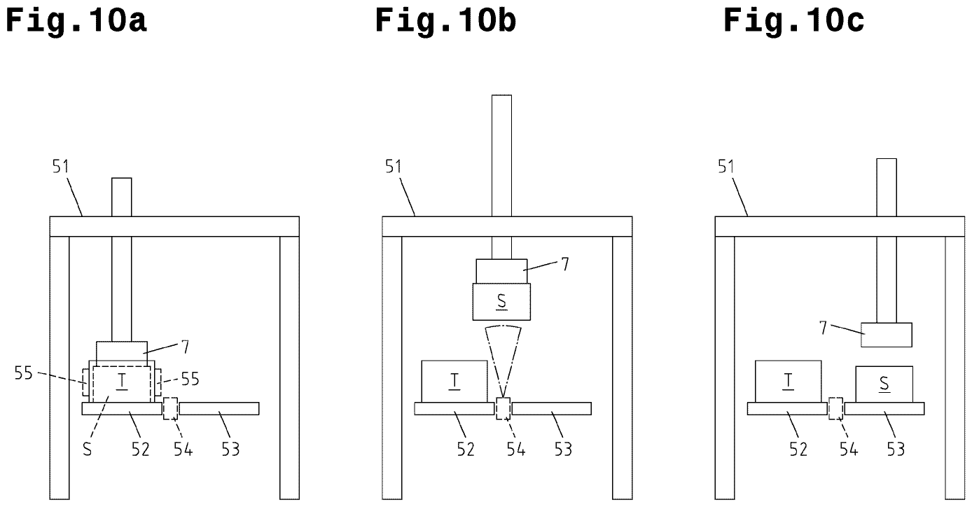

FIG. 9a to FIG. 9d show a putting of the receiving container T over the transferring container S. To grip the receiving container T, the gripping unit 7 can comprise multiple gripping elements 71, which can be configured as suction grippers or as clamp grippers, for example.

Furthermore, the gripping unit 7 can have multiple, in particular four, optional pressing elements 72 in order to center the transferring container S relative to and/or in the receiving container T during the putting-over. The pressing elements 72 are preferably arranged in mutually opposite pairs, so that the pressing elements 72 are adjustable to the side walls of the transferring container S. Preferably, the pressing elements 72 are mounted at the gripping unit 7 so as to be movable, for example pivotable about a pivot axis.

During the putting-over, the pressing elements 72 can be adjusted, for example deflected, from an initial position shown in FIG. 9a to a press position shown in FIG. 9b. In the press position, opposite pressing elements 72 are spaced apart such that the opposite pressing elements 72 are positioned against opposite side walls of the transferring container S when the gripping unit 7 is lowered and optionally push each of the opposite side walls toward the respectively opposite side wall, as shown in FIG. 9b and FIG. 9c. A distance between opposite pressing elements 72 in the respective press position preferably corresponds maximally to a width or length of the receiving container.

Preferably, the pressing elements 72 are arranged so as to be inclined in the press position, so that opposite pressing elements 72 essentially form a funnel here that tapers off upwardly. Top edges of side walls of the transferring container S are thus essentially inserted in the receiving container T.

When the receiving container T is put over the transferring container S, the pressing elements 72 can be moved out of the press position to the initial position again, as shown in Fig. d.

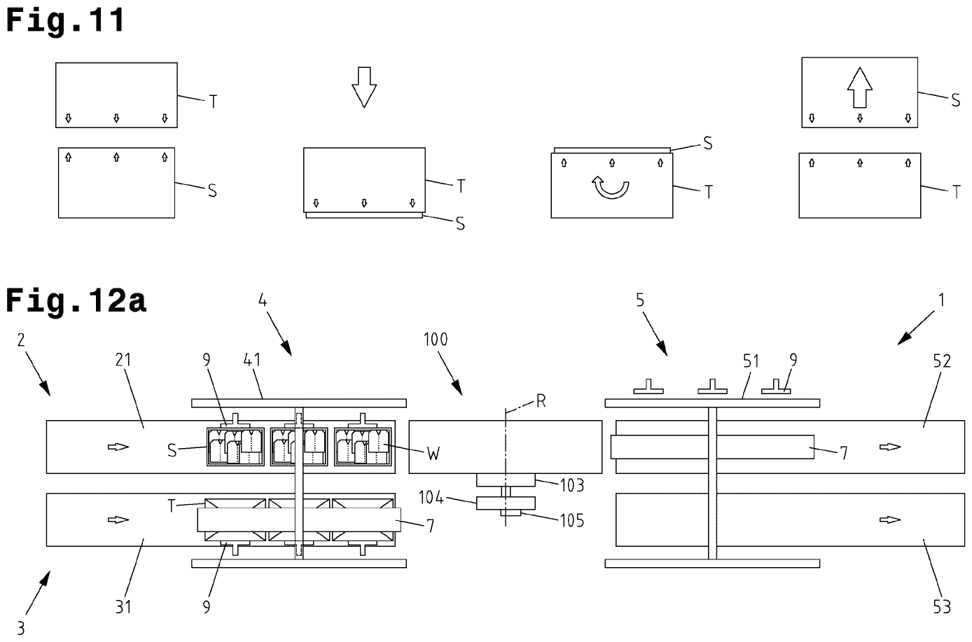

FIG. 10a to FIG. 10c show the removal station 5 in a front view. The gripping unit 7 of the removal station 5 is configured for receiving the transferring containers S.

On the one hand, the removal station 5 comprises the first removal conveying device 52, on which the turning pairs are provisioned, as shown in FIG. 10a. On the other hand, the removal station 5 comprises the second removal conveying device 53, using which transferring containers S that have been removed from the receiving containers T can be transported away, as can be seen in FIG. 10c.

When removing the transferring container S from the receiving container T, in particular in order to separate a turning pair, the gripping unit 7 of the removal device 51 is first positioned above the turning pair, as indicated in FIG. 10a. Subsequently, the transferring containers S are received and lifted by the gripping unit 7, wherein the transferring containers S are removed from the receiving containers T. It is expedient here if the receiving container T is retained and/or fixed by an optional retaining device 55 of the removal station, as represented in FIG. 10a. The retaining device comprises, to that end, preferably mutually opposite clamping elements (in pairs). For reasons of clarity, the retaining device is not represented in FIG. 10b and FIG. 10c.

The transferring container S removed from the receiving container T is handed over from the first removal conveying device 52 to the second removal conveying device 53 by the removal device 51, as can be gleaned from a combination of FIG. 10b and FIG. 10c.

To examine whether the transferring container S is empty, the removal station can have an optional checking device 54, which has in particular a sensor system for detecting an interior of the transferring container S, for example a camera, an ultrasonic sensor or suchlike. The checking device 54 is arranged between the first and second removal conveying devices 52, 53, for example. The transferring container S can thus be moved across the checking device 54 by the removal device 51, as shown in FIG. 10b, wherein the checking device 54 can detect an interior of the transferring container.

Finally, the receiving containers T now filled with articles can be transported away. Furthermore, the transferring containers S can be transferred to the second removal conveying device 53 and transported to a disposal point, for example, as shown in FIG. 10c.

It can be provided that the gripping unit 7 of the removal device 51 is dimensioned such that it can receive multiple, in particular three, transferring containers S, as represented below in FIG. 12a to FIG. 12e. Multiple, in particular three, turning pairs can thus be separated simultaneously.

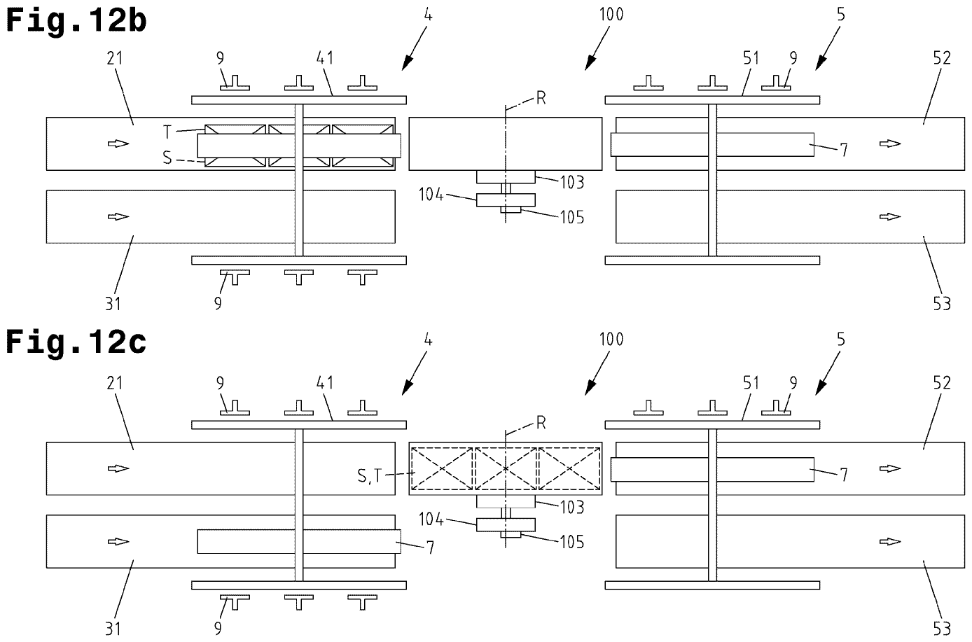

FIG. 11 shows a schematic representation of an operating principle of the transfer device 1. Here, a transferring container S filled with an article is first provisioned in upright orientation, i.e. with its open side upward, and a, in particular empty, receiving container T is provisioned in upside-down orientation, i.e. with its open side downward. The open sides of the respective containers S, T are indicated in FIG. 11 by three small arrows each.

Subsequently, the receiving container T is put over the transferring container S, as indicated by a downward-pointing arrow. The turning pair thus formed, which comprises the transferring container S and the receiving container T, is turned by a rotation by 180°, as indicated by a curved arrow.

Finally, the transferring container S can be removed from the receiving container T. This is indicated by an upward-pointing arrow. Here, the article is transferred to the receiving container T. The transferring container S is now in the upside-down orientation, whereas the receiving container T is in the upright orientation.

Optionally, two or multiple (small) transferring containers S can be provisioned and the receiving container T can be put over the two or multiple transferring containers S if articles are to be transferred from multiple small transferring containers S to a (single) large receiving container T, for example. In this case, the turning pair comprises a receiving container T and two or multiple transferring containers S. The turning pair can now be turned and the two or multiple transferring containers S can subsequently be removed from the receiving container T by the removal device 51.

FIG. 12a to FIG. 12e show the transfer device 1 in a simplified representation in a top view. In a method for transferring an article from a transferring container S to a receiving container T, transferring containers S are provisioned at the put-over station 4 by the first provisioning device 2 and receiving containers T are provisioned at the put-over station 4 by the second provisioning device 3 in a first and second step i) and ii), as shown in FIG. 12a.

Here, the transferring containers S can be transported to the put-over station 4 by the transferring container conveying device 21 and the receiving containers T can be transported to the put-over station 4 by the receiving container conveying device 31a, 31b. The conveying direction is indicated by an arrow here. Particularly preferably, the transferring containers S and/or the receiving containers T are positioned by the positioning elements 8 and/or aligned by the pushing elements 9 in steps i) and ii), as described above.

In a subsequent step iii), the putting-over takes place, wherein the provisioned receiving containers T are put over the transferring containers S by the put-over device 41, as indicated in FIG. 12b. Step iii) is preferably executed as described in relation to FIG. 8a to FIG. 8c.

The putting of the receiving containers T over the transferring containers S results in the forming of the turning pairs, which are subsequently handed over to the turning device 100.

In a fourth step iv), the turning pairs are positioned in the turning device 100 and rotated about the axis of rotation R of the turning device 100 by the turning device 100 in order to turn the turning pairs, as schematically represented in FIG. 12c. The turning is preferably executed as described above in relation to the turning device 100.

Subsequently, the now turned turning pairs are provisioned at the removal station 5 as shown in FIG. 12d. Here, the turning pairs can be handed over to the first removal conveying device 52 and provisioned in the operating range of the removal device 51 by the turning device 100.

The turning pairs provisioned at the removal station 5 can be separated in a subsequent step v) by removing the transferring containers S from the receiving containers T by the removal device 51, in particular as described above in relation to FIG. 10a to FIG. 10c.

The receiving containers T can further be handed over to the second removal conveying device 53 and transported away from the removal device 51 by the second removal conveying device 53. This is represented in FIG. 12e. The receiving containers T can be transported away from the removal device 51 and transported to a container storage, for example, by the first removal conveying device 52.

The method can be executed sequentially for one transferring container S and one receiving container T each or simultaneously for multiple, in particular three, transferring containers S and receiving containers T, as represented in FIG. 12a to FIG. 12e, wherein also multiple, in particular three, turning pairs are formed.

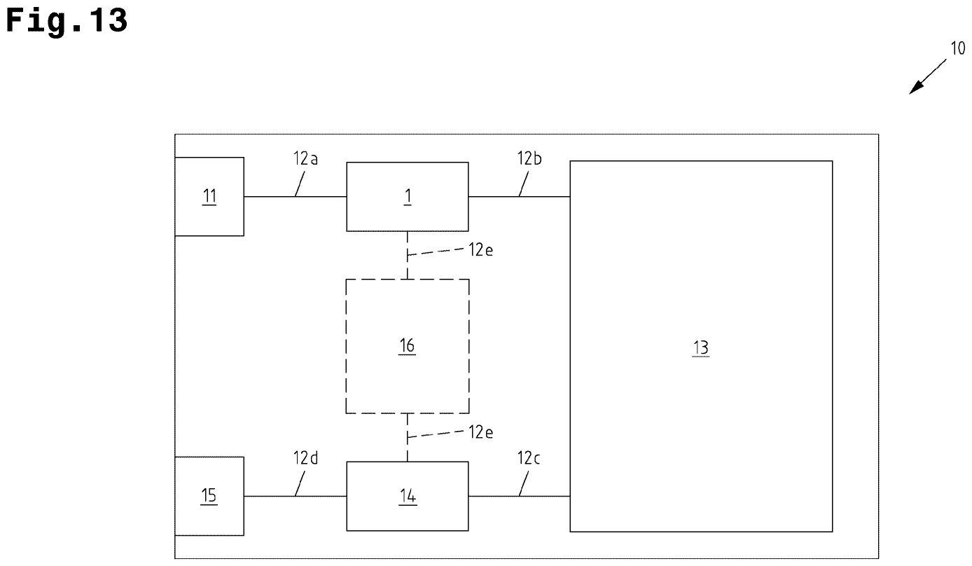

FIG. 13 shows a schematic representation of an order picking warehouse 10 with a transfer device 1, which is configured according to one of the aspects described above.

The order picking warehouse 10 comprises an article receipt 11 for receiving articles, which are supplied in transferring containers S, for example in supply containers. The transferring containers S can be transported from the article receipt 11 to the transfer device 1. To that end, the order picking warehouse 10 can comprise a supply conveying system 12a, which connects the article receipt 11 and the transfer device 1 in terms of conveyance. Alternatively, the transfer device 1 can be arranged so as to immediately adjoin the article receipt 11.

Supplied articles can be decanted, i.e. transferred from the transferring containers S to, in particular storable, receiving containers T, for example cases, by the transfer device 1.

Furthermore, the order picking warehouse 10 comprises an article storage 13 for storing receiving containers T filled with articles. It is provided here that the order picking warehouse 10 has a storage conveying system 12b for transporting the receiving containers T between the transfer device 1 and the article storage 13. The storage conveying system 12b preferably adjoins the first removal conveying device 52 of the transfer device 1 in terms of conveyance.

The order picking warehouse 10 further comprises a picking station 14, preferably with at least one picking device for reloading articles from the receiving containers T into shipping containers according to picking orders. Here, it is provided that the order picking warehouse 10 has a picking conveying system 12c for transporting the receiving containers T between the article storage 13 and the picking station 14.

It can further be provided that the order picking warehouse 10 comprises an article issue 15, which is connected to the picking station 14 in terms of conveyance via a shipping conveying system 12d.

Optionally, the order picking warehouse 10 comprises a receiving container buffer 16 for buffering or storing empty receiving containers T.

Furthermore, it can be provided that the order picking warehouse 10 comprises an empties conveying system 12e, which connects the picking station 14 and the transfer device 1, the picking station 14 and the receiving container buffer 16 and/or the receiving container buffer 16 and the transfer device 1 in terms of conveyance. The empties conveying system 12e preferably adjoins the receiving container conveying device 31a, 31b, in particular the first conveying section 31a, in terms of conveyance in order to transport empty receiving containers T from the picking station 14 and/or from the receiving container buffer 16 to the transfer device 1.

Finally, it should also be noted that the scope of protection is determined by the claims. However, the description and the drawings are to be adduced for construing the claims. Individual features or feature combinations from the different exemplary embodiments shown and described may represent independent inventive solutions.

In particular, it should also be noted the devices depicted may, in reality, also comprise more, or also fewer, components than depicted. In some cases, the shown devices and/or their components may not be depicted to scale and/or be enlarged and/or reduced in size.

Table of reference numbers

| | |
|---|---|
| 1 | transfer device |
| 2 | first provisioning device |
| 21 | transferring container conveying device |
| 3 | second provisioning device |
| 31a, 31b | receiving container conveying device |
| 31a | first conveying section |
| 31b | second conveying section |
| 4 | put-over station |
| 41 | put-over device |
| 42 | transferring container provisioning conveyor |
| 43 | receiving container provisioning conveyor |
| 5 | removal station |
| 51 | removal device |
| 52 | first removal conveying device |
| 53 | second removal conveying device |
| 54 | checking device |
| 55 | retaining device |
| 6 | container flipper |
| 61 | chute |
| 62 | tipping edge |
| 63 | lateral guide |
| 64 | guide element |
| 65 | first catch arm |
| 66 | second catch arm |
| 67 | drive shaft |
| 7 | gripping unit |
| 71 | gripping elements |
| 72 | pressing elements |
| 8 | positioning element |
| 9 | pushing element |
| 10 | order picking warehouse |
| 11 | article receipt |
| 12a . . . 12e | conveying system |
| 13 | article storage |
| 14 | picking station |
| 15 | article issue |
| 16 | receiving container buffer |
| 100 | turning device |
| 101 | first turning conveying device |
| 102 | second turning conveying device |
| 103 | pivoting frame |
| 104 | support structure |
| 105 | rotary drive |
| 106 | conveyor roller |
| 106′ | motor roller |
| 107 | clamping element |
| 108 | other clamping element |
| 109 | stop element |
| 110 | rotor |
| 111 | stator |
| 112 | brake |
| 113 | roller axle |
| 114 | frame profile |
| 115 | belt transmission |
| 116 | roller body |
| 117 | guide groove |
| FE′ | first conveying plane |
| FE″ | second conveying plane |
| R | axis of rotation |
| S | transferring container |
| T | receiving container |
| W | article |

1. A turning device for containers, in particular a turning pair comprising a transferring container and a receiving container put over the transferring container, with a container manipulation unit for transporting and turning the containers and a rotating device for rotating the container manipulation unit, wherein the container manipulation unit comprises:
a first turning conveying device with a first conveying plane; and
a second turning conveying device with a second conveying plane, wherein the first and second conveying planes are arranged mutually opposite and facing each other, and wherein the containers can be positioned between the first and second turning conveying devices; and
wherein the rotating device comprises:
a pivoting frame; and
a support structure, wherein the pivoting frame is mounted at the support structure so as to be rotatable about an axis of rotation and the first and second turning conveying devices are arranged at the pivoting frame.

2. The turning device according to claim 1, wherein the first and second turning conveying devices each comprise multiple conveyor rollers, wherein at least one conveyor roller of the conveyor rollers, respectively, is configured as a motor roller with a drive device.

3. The turning device according to claim 1, wherein the container manipulation unit comprises a clamping device, which is configured for fixing the containers between the first and second turning conveying devices.

4. The turning device according to claim 2, wherein the motor roller comprises a roller axle and a roller body mounted so as to be rotatable relative thereto and the drive device comprises an electric motor which is arranged inside the roller body.

5. The turning device according to claim 1, wherein the first and/or second turning conveying devices each have one or multiple roller groups, wherein each roller group comprises a conveyor roller configured as a motor roller and multiple passive conveyor rollers, wherein the passive conveyor rollers of a roller group are connected to the motor roller of the roller group via a belt transmission in order to transmit a driving force from the motor roller to the passive conveyor rollers.

6. The turning device according to claim 1, wherein the container manipulation unit further comprises a braking system, using at least one of the conveyor rollers, of the first turning conveying device and/or at least one of the conveyor rollers, of the second turning conveying device can be acted upon by a holding force.

7. The turning device according to claim 3, wherein the clamping device has an adjusting mechanism, wherein the first turning conveying device and second turning conveying device are mounted at the pivoting frame so as to be movable relative to each other by the adjusting mechanism, so that a normal distance between the first and second conveying planes is variable in order to clamp the containers between the first and second conveying planes for turning.

8. The turning device according to claim 1, wherein the first and second turning conveying devices are rigidly connected to the pivoting frame.

9. The turning device according to claim 3, wherein the clamping device has at least one clamping element, which is movable along a clamping direction between an initial position of the clamping element, which is retracted in relation to the second conveying plane, and a clamped position of the clamping element, which protrudes in relation to the second conveying plane.

10. The turning device according to claim 9, wherein the clamping device has at least one other clamping element, which is movable along the clamping direction between an initial position of the other clamping element, which is retracted in relation to the first conveying plane, and a clamped position of the other clamping element, which protrudes in relation to the first conveying plane.

11. The turning device according to claim 1, wherein the container manipulation unit further comprises a securing system for limiting a displacement movement of the containers when the containers are positioned between the first turning conveying device and second turning conveying device for turning, wherein the securing system comprises:
two stop elements, which are assigned to the first turning conveying device and which are arranged at opposite ends of the first turning conveying device and are movable between an initial position, which is retracted in relation to the first conveying plane and in which the containers are movable past the stop element along the first turning conveying device, and a securing position, which protrudes in relation to the first conveying plane and in which a displacement of the containers along the first turning conveying device is limited, and/or
two stop elements, which are assigned to the second turning conveying device and which are arranged at opposite ends of the second turning conveying device and are movable between an initial position, which is retracted in relation to the second conveying plane and in which the containers are movable past the stop element along the second turning conveying device, and a securing position, which protrudes toward the first conveying plane in relation to the second conveying plane and in which a displacement of the containers along the second turning conveying device is limited.

12. The turning device according to claim 1, wherein the container manipulation unit is configured for simultaneously receiving multiple containers, in particular multiple turning pairs, and the rotating device is configured for simultaneously turning the containers, in particular multiple turning pairs.

13. The turning device according to claim 3, wherein the clamping device has:
multiple individually movable clamping elements, wherein a first one of the clamping elements is assigned to a first receiving position for a first one of the multiple containers, and a second one of the clamping elements is assigned to a second receiving position for a second one of the multiple containers, and/or
multiple individually movable other clamping elements, wherein a first one of the other clamping elements is assigned to a first receiving position for a first one of the multiple containers, and a second one of the other clamping elements is assigned to a second receiving position for a second one of the multiple containers.

14. A method for turning containers by a turning device, comprising the following steps:
a) provisioning a container manipulation unit for transporting and turning the containers which comprises a first turning conveying device and a second turning conveying device, wherein the first turning conveying device forms a first conveying plane and the second turning conveying device forms a second conveying plane, wherein the first conveying plane and the second conveying plane are arranged at a normal distance from each other and opposite each other,
b) provisioning at least one container in the container manipulation unit between the first turning conveying device and the second turning conveying device,
c) optionally fixing the container between the first turning conveying device and the second turning conveying device of the container manipulation unit,
d) rotating the container manipulation unit about a horizontal axis of rotation and turning the container,
e) transferring the container to the second turning conveying device, and
f) transporting the container out of the container manipulation unit.

15. The method according to claim 14, wherein a plurality of containers are provisioned so as to be singularized, and
step c) is executed for the provisioned containers simultaneously, and/or
step d) is executed for the provisioned containers simultaneously, and/or
step e) is executed for the provisioned containers simultaneously, and/or
step f) is executed for the provisioned containers simultaneously.

16. A method for turning containers using a turning device, comprising the following steps:
a) provisioning a container manipulation unit for transporting and turning the containers which comprises a first turning conveying device and a second turning conveying device, wherein the first turning conveying device forms a first conveying plane and the second turning conveying device forms a second conveying plane, wherein the first conveying plane and the second conveying plane are arranged at a normal distance from each other and opposite each other,
b) provisioning a turning pair, comprising a transferring container and a receiving container put over the transferring container, in the container manipulation unit between the first turning conveying device and the second turning conveying device by depositing the transferring container with its bottom on the first conveying plane,
c) optionally fixing the turning pair between the first turning conveying device and the second turning conveying device of the container manipulation unit, in particular by a clamping device of the container manipulation unit,
d) rotating the container manipulation unit about a horizontal axis of rotation and turning the turning pair,
e) transferring the turning pair to the second turning conveying device, wherein the receiving container of the turning pair is deposited with its bottom on the second conveying plane, and
f) transporting the turning pair out of the container manipulation unit.

17. The method according to claim 16, wherein:
the first turning conveying device of the container manipulation unit provisioned in step a) comprises at least one self-driven motor roller with a drive device and the second turning conveying device of the container manipulation unit provisioned in step a) comprises a self-driven motor roller with a drive device,
the at least one motor roller of the first turning conveying device is driven by its drive device in order to position the turning pair in the container manipulation unit in step b), and
the turning pair is transported out of the container manipulation unit by driving the at least one motor roller of the second turning conveying device by its drive device in step f).

18. The method according to claim 17, wherein a plurality of turning pairs are provisioned in step b) and
step c) is executed for the provisioned turning pairs simultaneously, and/or
step d) is executed for the provisioned turning pairs simultaneously, and/or
step e) is executed for the provisioned turning pairs simultaneously, and/or
step f) is executed for the provisioned turning pairs simultaneously.

19. The method according to claim 16, wherein the clamping device has an adjusting mechanism, wherein;
the first and second turning conveying devices are moved relative to each other along a clamping direction by the adjusting mechanism in step c), whereby the normal distance between the first and second conveying planes is reduced until the second conveying plane is positioned against the bottom of the receiving container of the turning pair in order to clamp the turning pair between the first and second conveying planes and fix the turning pair during the turning in step d), or until the second conveying plane is positioned against the bottom of the container in order to clamp the container between the first and second conveying planes and fix the container during the turning in step d), and
the first and second turning conveying devices are moved relative to each other along the clamping direction by the adjusting mechanism in step e), whereby the normal distance between the first and second conveying planes is enlarged in order to release a fixing of the turning pair or of the container.

20. The method according to claim 16, wherein the clamping device has at least one clamping element, which is movable along a clamping direction between an initial position, which is retracted in relation to the second conveying plane, and a clamped position, which protrudes in relation to the second conveying plane, wherein;
the at least one clamping element is moved from the initial position to the clamped position in step c) in order to clamp the turning pair between the at least one clamping element and the first conveying plane and fix the turning pair during the turning in step d) or in order to clamp the container between the at least one clamping element and the first conveying plane and fix the container during the turning in step d), and
the at least one clamping element is moved from the clamped position along the clamping direction to the initial position in step e), wherein the turning pair or the container is lowered and transferred onto the second conveying plane.

21. The method according to claim 14, wherein the clamping elements are individually movable and a first one of the clamping elements fixes a first one of the multiple containers in step c) and releases the first one of the multiple containers in step e) and a second one of the clamping elements fixes a second one of the multiple containers in step c) and releases the second one of the multiple containers in step e).

22. The method according to claim 14, wherein the at least one self-driven motor roller of the first turning conveying device and/or the at least one self-driven motor roller of the second turning conveying device is acted upon by a holding force in step d).

23. The method according to claim 14, wherein the container manipulation unit comprises a securing system for limiting a displacement movement of the containers, and the securing system is activated in step c) and deactivated in step e).

24. The method according to claim 23, wherein the securing system comprises two stop elements which are assigned to the first turning conveying device and which are arranged at opposite ends of the first turning conveying device and are movable between an initial position, which is retracted in relation to the first conveying plane and in which the turning pair or the container is movable past the stop element along the first turning conveying device, and a securing position, which protrudes in relation to the first conveying plane and in which a displacement of the turning pair or container along the first turning conveying device is limited, wherein the stop elements assigned to the first turning conveying device are moved from the initial position to the securing position to activate the securing system and from the securing position to the initial position to deactivate the securing system.

25. The method according to claim 23, wherein the securing system comprises two stop elements which are assigned to the second turning conveying device and which are arranged at opposite ends of the second turning conveying device and are movable between an initial position, which is retracted in relation to the second conveying plane and in which the turning pair or the container is movable past the stop element along the second turning conveying device, and a securing position, which protrudes in relation to the second conveying plane and in which a displacement of the turning pair or container along the second turning conveying device is limited, wherein the stop elements assigned to the second turning conveying device are moved from the initial position to the securing position to activate the securing system and from the securing position to the initial position to deactivate the securing system.

26. A method for transferring an article from a transferring container to a receiving container by a transfer device, comprising the steps:
i) provisioning a transferring container containing an article in an upright orientation at a put-over station by a first provisioning device,
ii) provisioning a receiving container in an upside-down orientation at the put-over station by a second provisioning device,
iii) putting the receiving container over the transferring container by an automatic put-over device, so that the transferring container is arranged at least partially in the receiving container, wherein a turning pair is formed, which comprises the transferring container and the receiving container put over the transferring container,
iv) turning the turning pair by an automatic turning device, wherein the receiving container of the turning pair is brought to an upright orientation and the transferring container of the turning pair is brought to an upside-down orientation and the transferring container remains in the receiving container,
v) provisioning the turning pair at a removal station and removing the transferring container from the receiving container by an automatic removal device, wherein the article is transferred to the receiving container.

27. The method according to claim 26, wherein the receiving container is transported to a container flipper of the transfer device in the upright orientation in step ii), subsequently flipped and thereby brought to the upside-down orientation by the container flipper, and finally transported from the container flipper to the put-over station.

28. The method according to claim 26, wherein the transferring container is transported to the put-over station by a transferring container conveying device in step i) and/or the receiving container is transported to the put-over station by a receiving container conveying device in step ii).

29. The method according to claim 28, wherein the receiving container is transported to a container flipper of the transfer device in the upright orientation in a first conveying section of the receiving container conveying device in step ii), flipped by the container flipper, wherein the receiving container is brought to the upside-down orientation, and transported from the container flipper to the put-over station in a second conveying section of the receiving container conveying device.

30. The method according to claim 29, wherein the first conveying section is arranged on a upper height level and the second conveying section is arranged on a lower height level and the container flipper comprises a chute that is arched at least in sections with a sliding surface, wherein the chute extends from the upper height level to the lower height level and a lower end of the chute adjoins the second conveying section, and the receiving container is tipped about a tipping edge and transferred onto the chute at an end of the first conveying section facing the chute in step ii), so that the receiving container at least partially rests with top edges of side walls of the receiving container on the sliding surface and is moved to the second conveying section along the chute and transferred to the second conveying section, wherein the receiving container is brought to the upside-down orientation.

31. The method according to claim 26, wherein the receiving container is aligned above the transferring container by the put-over device, and lowered such that the receiving container is put over the transferring container in step iii), wherein the transferring container is received in the receiving container.

32. The method according to claim 31, wherein side walls of the transferring container are each pressed toward a respective opposite side wall by pressing elements when putting the receiving container over the transferring container in order to center the transferring container in the receiving container.

33. The method according to claim 26, wherein step iv) comprises:
turning the turning pair by rotating a container manipulation unit about a horizontal axis of rotation, wherein the turning device comprises the container manipulation unit and wherein in particular the container manipulation unit is configured for transporting and turning the containers and/or the turning pair.

34. The method according to claim 33, wherein the container manipulation unit comprises a first turning conveying device and a second turning conveying device and is in particular provisioned before step iv).

35. The method according to claim 34, wherein the first turning conveying device forms a first conveying plane and the second turning conveying device forms a second conveying plane, wherein the first conveying plane and the second conveying plane are arranged at a normal distance from each other and opposite each other.

36. The method according to claim 34, wherein the first turning conveying device is equipped with at least one self-driven motor roller with a drive device and the second turning conveying device is equipped with a self-driven motor roller with a drive device.

37. The method according to claim 34, wherein the turning pair is fixed between the first turning conveying device and the second turning conveying device of the container manipulation unit by a clamping device of the container manipulation unit.

38. The method according to claim 26, wherein the turning in step iv) comprises the following steps:
transporting the turning pair from the put-over station to the turning device,
handing over the turning pair to a container manipulation unit of the turning device,
turning the turning pair, and
handing over the turning pair to the removal station.

39. A method for transferring an article from a transferring container to a receiving container by a transfer device, comprising the steps:
i) provisioning a transferring container containing an article in an upright orientation at a put-over station by a first provisioning device,
ii) provisioning a receiving container in an upside-down orientation at the put-over station by a second provisioning device,
iii) putting the receiving container over the transferring container by an automatic put-over device, so that the transferring container is arranged at least partially in the receiving container, wherein a turning pair is formed, which comprises the transferring container and the receiving container put over the transferring container,
iv-a) provisioning a container manipulation unit for transporting and turning the containers which comprises a first turning conveying device and a second turning conveying device, wherein the first turning conveying device forms a first conveying plane and the second turning conveying device forms a second conveying plane, wherein the first conveying plane and the second conveying plane are arranged at a normal distance from each other and opposite each other,
iv-b) transporting the turning pair from the put-over station to the turning device,
iv-c) handing over the turning pair, comprising the transferring container and the receiving container put over the transferring container, at the container manipulation unit between the first turning conveying device and the second turning conveying device by depositing the transferring container with its bottom on the first conveying plane,
iv-d) optionally fixing the turning pair between the first turning conveying device and the second turning conveying device of the container manipulation unit, in particular by a clamping device of the container manipulation unit,
iv-e) rotating the container manipulation unit about a horizontal axis of rotation and turning the turning pair,
iv-f) transferring the turning pair to the second turning conveying device, wherein the receiving container of the turning pair is deposited with its bottom on the second conveying plane,
iv-g) in case of step iv-d) releasing the turning pair by the clamping device,
iv-h) transporting the turning pair out of the container manipulation unit,
iv-i) handing over the turning pair to the removal station, and
v) removing the transferring container from the receiving container by an automatic removal device, wherein the article is transferred to the receiving container.

40. The method according to claim 39, wherein:
the first turning conveying device of the container manipulation unit provisioned in step iv-a) comprises at least one self-driven motor roller with a drive device and the second turning conveying device of the container manipulation unit provisioned in step iv-a) comprises a self-driven motor roller with a drive device,
the at least one motor roller of the first turning conveying device is driven by its drive device in order to position the turning pair in the container manipulation unit in step iv-c), and
the turning pair is transported out of the container manipulation unit in step iv-h) by driving the at least one motor roller of the second turning conveying device by its drive device.

41. The method according to claim 26, wherein the removing of the transferring container in step v) is executed by seizing and lifting the transferring container from above by the removal device, in particular by a removal robot unit, wherein the transferring container is removed from the receiving container.

42. The method according to claim 26, wherein the receiving container is retained by a retaining device during step v).

43. The method according to claim 26, wherein the transferring container is shaken during step v).

44. The method according to claim 26, further comprising the step:
vi) transporting the receiving container away from the turning device by a first removal conveying device and/or transporting the transferring container away from the turning device by a second removal conveying device.

45. The method according to claim 26, wherein a plurality of transferring containers are provisioned in step i) and a plurality of receiving containers, are provisioned in step ii), wherein a number of provisioned transferring containers corresponds to a number of provisioned receiving containers, and
step iii) is executed for the provisioned transferring containers and receiving containers, wherein one receiving container is put over one transferring container, respectively, in order to form a plurality of turning pairs, and/or
step iv) is executed for the turning pairs formed in step iii) simultaneously, and/or
step v) is executed for the turning pairs turned in step iv) simultaneously.

46. The method according to claim 26, wherein step iv) comprises the following step:
fixing the turning pair or the plurality of turning pairs between a first turning conveying device and a second turning conveying device of the container manipulation unit by a clamping device of the container manipulation unit, before the turning of the turning pair or of the plurality of turning pairs by rotating the container manipulation unit about a horizontal axis of rotation.

47. The method according to claim 46, wherein at least one clamping element of the clamping device is moved along a clamping direction to a clamped position, which protrudes beyond the second conveying plane, to clamp the turning pair and is moved along the clamping direction to an initial position, which is retracted in relation to the second conveying plane, to release the turning pair, wherein the second turning conveying device forms the second conveying plane, and/or at least one other clamping element of the clamping device is moved along a clamping direction to a clamped position, which protrudes beyond the first conveying plane, to clamp the turning pair and is moved along the clamping direction to an initial position, which is retracted in relation to the first conveying plane, to release the turning pair, wherein the first turning conveying device forms the first conveying plane.

48. The method according to claim 46, wherein a plurality of clamping elements of the clamping device are each moved along a clamping direction to a clamped position, which protrudes beyond the second conveying plane, to clamp the turning pairs and are each moved along the clamping direction to an initial position, which is retracted in relation to the second conveying plane, to release the turning pairs, wherein the second turning conveying device forms the second conveying plane and/or a plurality of other clamping elements of the clamping device are each moved along a clamping direction to a clamped position, which protrudes beyond the first conveying plane, to clamp the turning pairs and moved along the clamping direction to an initial position, which is retracted in relation to the first conveying plane, to release the turning pairs, wherein the first turning conveying device forms the first conveying plane.

49. The method according to claim 48, the clamping elements are individually movable and a first one of the clamping elements fixes a first one of the multiple turning pairs, in particular in step iv-d), or releases the first one of the multiple turning pairs, in particular in step iv-g), and a second one of the clamping elements fixes a second one of the multiple turning pairs, in particular in step iv-d), or releases the second one of the multiple turning pairs, in particular in step iv-g), and/or the other clamping elements are individually movable and a first one of the other clamping elements fixes a first one of the multiple turning pairs, in particular in step iv-d), or releases the first one of the multiple turning pairs, in particular in step iv-g), and a second one of the other clamping elements fixes a second one of the multiple turning pairs, in particular in step iv-d), or releases the second one of the multiple turning pairs, in particular in step iv-g).

50. The method according to claim 39, wherein a displacement movement of the containers is limited by a securing system of the container manipulation unit when the containers are positioned between the first turning conveying device and second turning conveying device for turning, wherein
two stop elements of the securing system, which are assigned to the first turning conveying device and which are arranged at opposite ends of the first turning conveying device, are moved along the first turning conveying device to a securing position, which protrudes beyond the first conveying plane, to limit a displacement of the containers and are moved along the first turning conveying device past the stop element to an initial position, which is retracted in relation to the first conveying plane, to release the containers and to enable a movement of the containers, and/or
two stop elements of the securing system, which are assigned to the second turning conveying device and which are arranged at opposite ends of the second turning conveying device, are moved along the second turning conveying device to a securing position, which protrudes beyond the second conveying plane, to limit a displacement of the containers, and are moved along the second turning conveying device past the stop element to an initial position, which is retracted in relation to the second conveying plane, to release the containers and to enable a movement of the containers.

51. A transfer device for transferring an article from a transferring container to a receiving container, comprising:
a first provisioning device for provisioning transferring containers,
a second provisioning device for provisioning receiving containers, and
a turning device for turning the transferring containers in order to transfer the article from the transferring container to the receiving container, wherein the transfer device-further comprises;
a put-over station with an automatic put-over device, and
a removal station with an automatic removal device,
wherein the first provisioning device is configured for provisioning transferring containers in an upright orientation at the put-over station,
the second provisioning device is configured for provisioning receiving containers in an upside-down orientation at the put-over station,
the put-over device is configured for receiving receiving containers provisioned at the put-over device and putting the receiving containers over transferring containers provisioned at the put-over device in order to form turning pairs from one transferring container along with the receiving container put over the transferring container, respectively,
the turning device is configured for taking over turning pairs from the put-over station, turning the turning pairs, so that the receiving container is aligned in the upright orientation and the transferring container is aligned in the upside-down orientation, and handing over the turning pairs to the removal station, and
the removal device is configured for removing transferring containers from receiving containers.

52. The transfer device according to claim 51, wherein the first provisioning device comprises a transferring container conveying device for transporting the transferring containers to the put-over station and/or the second provisioning device comprises a receiving container conveying device for transporting the receiving containers to the put-over station.

53. The transfer device according to claim 51, wherein the second provisioning device has a container flipper, which is configured for flipping a receiving container provisioned in upright orientation at the container flipper in order to bring the receiving container to the upside-down orientation.

54. The transfer device according to claim 52, wherein the receiving container conveying device comprises a first conveying section for transporting the receiving container to the container flipper and a second conveying section for transporting the receiving container from the container flipper to the put-over station.

55. The transfer device according to claim 53, wherein the container flipper comprises a robot unit and/or a turning device, for turning the receiving container.

56. The transfer device according to claim 54, wherein the first conveying section is arranged on a upper height level and the second conveying section is arranged on a lower height level, and the container flipper comprises a chute that is arched, wherein the chute extends from the upper height level to the lower height level and a lower end of the chute adjoins the second conveying section.

57. The transfer device according to claim 56, wherein the container flipper has a tipping edge, which is arranged at an end of the first conveying section facing the chute and adjoins the first conveying section, and the sliding surface is arranged spaced apart from the tipping edge, in particular parallel to it.

58. The transfer device according to claim 56, wherein the container flipper comprises two mutually opposite lateral guides, which protrude from the sliding surface toward the first conveying section and limit the sliding surface laterally.

59. The transfer device according to claim 56, wherein the container flipper comprises a guide element, which is arranged opposite the sliding surface, in order to guide the receiving container along the chute.

60. The transfer device according to claim 56, wherein the container flipper comprises a stopping device, which is configured for stopping the receiving container along a sliding path, which leads along the chute from a upper end of the chute to a lower end of the chute, wherein the stopping device comprises a first catch arm, which is arranged between the upper end of the chute and the lower end of the chute and is adjustable between a catch position, in which the first catch arm has been moved into the sliding path, and a release position, in which the first catch arm has been moved out of the sliding path.

61. The transfer device-according to claim 60, wherein the stopping device comprises a second catch arm, which is arranged between the upper end of the chute and the first catch arm and is adjustable between a catch position, in which the second catch arm has been moved into the sliding path, and a release position, in which the second catch arm has been moved out of the sliding path.

62. The transfer device according to claim 61, wherein the first catch arm and the second catch arm are coupled with each other such that the second catch arm is moved to the release position when the first catch arm is moved to the catch position, and the second catch arm is moved to the catch position when the first catch arm is moved to the release position.

63. The transfer device according to claim 51, wherein the put-over station comprises a transferring container provisioning conveyor for provisioning the transferring containers at the put-over device and/or a receiving container provisioning conveyor for provisioning the receiving containers at the put-over device.

64. The transfer device according to claim 63, wherein the transferring container provisioning conveyor and/or the receiving container provisioning conveyor each form a conveying plane and each comprise at least one positioning element, which are movable between an initial position of the positioning elements, which is retracted in relation to the conveying plane, and a stop position, which protrudes in relation to the conveying plane.

65. The transfer device according to claim 63, wherein the put-over station comprises an alignment device, which has horizontally extendable pushing elements for sliding the transferring containers on the transferring container provisioning conveyor and/or horizontally extendable pushing elements for sliding the receiving containers on the receiving container provisioning conveyor.

66. The transfer device according to claim 51, wherein the put-over device comprises a gripping unit, which is configured for receiving at least one receiving container.

67. The transfer device according to claim 51, wherein the gripping unit has multiple pressing elements, in particular pressing elements that are movable and/or form a funnel, which are adjustable to side walls of the transferring container in order to center the transferring container in the receiving container when putting over the receiving container.

68. The transfer device according to claim 51, wherein the removal station comprises a first removal conveying device for taking over turning pairs from the turning device, for provisioning the turning pairs at the removal device and for transporting the receiving containers away from the turning device and optionally a second removal conveying device for taking over transferring containers from the removal device and for transporting the transferring containers away from the turning device.

69. The transfer device according to claim 68, wherein the first removal conveying device forms a conveying plane and comprises at least one positioning element, which is movable between an initial position, which is retracted in relation to the conveying plane, and a stop position, which protrudes in relation to the conveying plane.

70. The transfer device according to claim 68, wherein the removal station comprises an alignment device, which has horizontally extendable pushing elements for sliding the turning pairs on the first removal conveying device.

71. The transfer device according to claim 51, wherein the removal device comprises a gripping unit, which is configured for receiving at least one transferring container.

72. The transfer device according to claim 51, wherein the removal station comprises a checking device, which is configured for examining whether the transferring container is empty after a removal of the transferring container from the receiving container.

73. An order picking warehouse for executing a method according to claim 39, comprising an article receipt for receiving articles, which are supplied in transferring containers, a transfer device for transferring the articles from the transferring containers to receiving containers, an article storage for storing the articles in the receiving containers, a picking station for reloading the articles from the receiving containers into shipping containers according to picking orders, a storage conveying system for transporting the receiving containers between the transfer device and the article storage and a picking conveying system for transporting the receiving containers between the article storage and the picking station.

74. An order picking warehouse for executing a method according to claim 26, comprising an article receipt for receiving articles, which are supplied in transferring containers, a transfer device for transferring the articles from the transferring containers to receiving containers, an article storage for storing the articles in the receiving containers, a picking station for reloading the articles from the receiving containers into shipping containers according to picking orders, a storage conveying system for transporting the receiving containers between the transfer device and the article storage and a picking conveying system for transporting the receiving containers between the article storage and the picking station.
